(19) United States
(12) Patent Application Publication
(10) Pub. No.: US 2015/0340061 A1
(43) Pub. Date: Nov. 26, 2015

(54) METHOD AND DEVICE FOR REPRODUCING CONTENT USING SCREEN COMPOSITION INFORMATION

(71) Applicant: SAMSUNG ELECTRONICS CO., LTD., Gyeonggi-do (KR)

(72) Inventors: Jong-ho YANG, Yongin-si (KR); Bong-gil BAK, Suwon-si (KR); Sung-ryeul RHYU, Yongin-si (KR); Min-Seok KIM, Suwon-si (KR)

(73) Assignee: SAMSUNG ELECTRONICS CO., LTD., Suwon-si (KR)

(21) Appl. No.: 14/649,380

(22) PCT Filed: Dec. 3, 2013
(86) PCT No.: PCT/KR2013/011127

§ 371 Date: Jun. 3, 2015

Related U.S. Application Data
(60) Provisional application No. 61/732,566, filed on Dec. 3, 2012.

(51) Int. Cl. G11B 20/10

(52) U.S. Cl. CPC G11B 20/10; G11B 2220/2562; G11B 2220/2541

(57) ABSTRACT

Provided are an information storage medium, and the information storage medium includes main content which is reproducible by a primary reproducing apparatus and at least one piece of screen composition information which includes information for obtaining additional content associated with the main content by a secondary reproducing apparatus and information for processing the additional content by the second reproducing apparatus.

### CROSS REFERENCE TO RELATED APPLICATIONS

This application is a national stage application of International Application No. PCT/KR2013/011127, filed on Dec. 3, 2013, and claims the benefit of the benefit of U.S. Provisional Patent Application No. 61/732,566, filed on Dec. 3, 2012, in the U.S. Patent and Trademark Office, and claims the benefit of Korean Patent Application No. 10-2013-149501, filed on Dec. 3, 2013, in the Korean Intellectual Property Office, the disclosures of which are incorporated herein by reference in their entireties.

### BACKGROUND

1. Field

Aspects of exemplary embodiments relate to a method and apparatus for providing a service associated with content not only to a reproducing apparatus for reproducing multimedia content but also to other apparatuses. More particularly, aspects of exemplary embodiments relate to a method and apparatus for reproducing content using screen composition information, and to an information storage medium having the screen composition information recorded thereon.

2. Description of Related Art

A general procedure of generating, distributing, and using multimedia content is as follows.

(1) A content manufacturer manufactures content.

(2) The content manufacturer records the manufactured content on a storage medium such as a Blu-ray disc, a Digital Versatile Disc/Digital Video Disc (DVD), a flash memory, or a hard disk.

(3) A user purchases the storage medium having content recorded thereon.

(4) The user enjoys the content via a reproducing apparatus that supports the purchased storage medium.

However, this conventional method is bothersome to both the content manufacturer and the user in terms of inflexibility, as will be described below. In the following description, a disk is illustrated as an example of a storage medium whose content is manufactured by a content manufacturer and used by a user, but the same description may also apply to any other type of a storage medium. A reproducing apparatus that plays back disks will be hereinafter referred to as a primary reproducing apparatus, and an apparatus having no disk playback capabilities but having a screen will be hereinafter referred to as a secondary reproducing apparatus.

(1) The content manufacturer must complete additional content or additional information associated with content, before starting to manufacture the disk. The user may want to purchase other associated content after the user has purchased the disk. However, in a conventional content providing method, since information about content of the disk is fixed at the time the disk is released, it is difficult to provide latest product information later.

(2) The user may enjoy the content via only a reproducing apparatus that plays back the disk, namely, a primary reproducing apparatus. Recently, most users have a mobile device such as, a mobile phone, a portable multimedia player (PMP), or a smartphone, and they want to enjoy content not only via a primary reproducing apparatus but also via a mobile device, namely, a secondary reproducing apparatus, no matter where they are.

(3) When several users enjoy together the content via a reproducing apparatus, the users may have different demands. However, a conventional method supports only a single screen, so the different demands are not satisfied. The different demands, for example, may be as follows.

\textcircled{1} Setting for enjoying content: Since users prefer different audio settings or subtitle settings, the users may require different things in order to enjoy the content that is being currently reproduced via a primary reproducing apparatus. For example, children may like dubbed voices, while adults may like native voices. Moreover, users may want subtitles in their desired languages.

\textcircled{2} Games: When there is a game associated with content that is being reproduced, users may want different games. Some users may want to play the game, and some users may not want to play the game.

\textcircled{3} Content-related information: When additional information such as, shopping information, comments on a movie, and a behind-the-scenes story of the movie, is provided as content-related information, users may want different information depending on their ages, genders, or tastes.

\textcircled{4} Additional video: When there exists additional videos associated with content currently being reproduced by a primary reproducing apparatus, users may want different additional videos according to their tastes. Alternatively, some users may want to play back additional videos, and other users may not.

\textcircled{5} Community: In some cases, while enjoying content, a user may want to connect to on-line communities such as, Face Book or Twitter, to upload information like a comment on the content.

According to the conventional method, after content recorded on a conventional storage medium, e.g., a disk, is released and delivered to a user, it is almost impossible to update or change the content recorded on the disk or to provide new information according to a content manufacturer's intention or user's various demands. Releasing a new disk satisfying new needs is a most common method to do so, but this method is inconvenient for both a disk purchaser and a manufacturer, and is also very costly.

### SUMMARY

According to an aspect of an exemplary embodiment, there is provided a non-transitory information storage medium having data recorded thereon, the data comprising: content which is reproducible by a primary reproducing apparatus; and screen composition information comprising information for providing additional content associated with the content to a secondary reproducing apparatus.

The screen composition information may further comprise information for reproducing the additional content by the secondary reproducing apparatus while the main content is being reproduced by the primary reproducing apparatus.

The screen composition information may further include information about a plurality of scenarios for providing different additional content to a plurality of secondary reproducing apparatuses.

The screen composition information may further include reproduction description information indicating a location of one of the additional content.

The data may further include, the additional content including at least one among subtitle information of the main content, secondary video information of the main content, secondary audio information of the main content, and information about an application associated with the main content.

The data may further include index information about the screen composition information.

According to another aspect of an exemplary embodiment, there is provided a reproducing apparatus, and the reproducing apparatus includes a reader configured to read content and screen composition information from an information storage medium, the screen composition information comprising information for providing additional content associated with the content to the secondary reproducing apparatus; a communicator configured to communicate with the secondary reproducing apparatus; a reproducer configured to reproduce the main content; and a controller configured to transmit the screen composition information to the secondary reproducing apparatus.

According to another aspect of an exemplary embodiment, there is provided a method of reproducing content in a reproducing apparatus, and the method includes the steps of reading content and screen composition information from an information storage medium, the screen composition information comprising information for providing additional content associated with the content to the secondary reproducing apparatus; reproducing the main content; and transmitting the screen composition information to the secondary reproducing apparatus.

According to another aspect of an exemplary embodiment, there is provided a computer-readable recording medium having recorded thereon a program for executing a method of reproducing content in a reproducing apparatus, and the method includes the steps of reading content and screen composition information from an information storage medium, the screen composition information comprising information for providing additional content associated with the content to the secondary reproducing apparatus; reproducing the main content; and transmitting the screen composition information to the secondary reproducing apparatus.

According to another aspect of an exemplary embodiment, there is provided a reproducing apparatus which includes a communicator configured to communicate with a primary reproducing apparatus which reproduces main content; a controller configured to receive screen composition information from the primary reproducing apparatus, and to obtain additional content associated with the content using the screen composition information; and a reproducer reproducing the obtained additional content using the screen composition information.

According to another aspect of an exemplary embodiment, there is provided a method of reproducing additional content in a reproducing apparatus, and the method includes the steps of, receiving screen composition information from a primary reproducing apparatus which reproduces main content; obtaining the additional content associated with the content using the screen composition information; and reproducing the additional content using the screen composition information.

According to another aspect of an exemplary embodiment, there is provided a computer-readable recording medium having recorded thereon a program for executing a method of reproducing additional content in a reproducing apparatus, and the method includes the steps of, receiving screen composition information from a primary reproducing apparatus which reproduces main content; obtaining the additional content associated with the content using the screen composition information; and reproducing the additional content using the screen composition information.

According to another aspect of an exemplary embodiment, there is provided a recording apparatus which includes a writer configured to write data to an computer-readable recording medium; and a controller configured to control the writer to write, to the computer-readable recording medium, content that is reproducible by a primary reproducing apparatus and screen composition information comprising information for providing additional content associated with the content to the secondary reproducing apparatus.

According to another aspect of an exemplary embodiment, there is provided a recording method which includes the steps of writing content that is to be reproducible by a primary reproducing apparatus, to an computer-readable recording medium; and writing, to the computer-readable recording medium, screen composition information comprising information for providing additional content associated with the content to the secondary reproducing apparatus.

According to another aspect of an exemplary embodiment, there is provided a computer-readable recording medium having recorded thereon a program for executing a recording method which includes the steps of, writing content that is to be reproducible by a primary reproducing apparatus, to an computer-readable recording medium; and writing, to the computer-readable recording medium, screen composition information comprising information for providing additional content associated with the content to the secondary reproducing apparatus

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram illustrating information that is recorded on an information storage medium according to an exemplary embodiment;

FIG. 2 is a block diagram illustrating a primary reproducing apparatus, a secondary reproducing apparatus, and a relationship between the two apparatuses, according to an exemplary embodiment;

FIG. 3 is a block diagram illustrating screen composition information recorded in a directory within a Blu-ray disk according to an exemplary embodiment;

FIG. 4 is a block diagram illustrating an arrangement of screen composition information associated with content distributed as one file within the file, according to an exemplary embodiment;

FIG. 5 is a schematic diagram illustrating a method of accessing screen composition information files using a screen composition information index, according to an exemplary embodiment;

FIG. 6 shows screen composition information index file according to an exemplary embodiment;

FIG. 7 is a schematic diagram for describing a structure of a screen composition information file according to an exemplary embodiment;

FIG. 8 is a view for describing screen composition information that is displayed by a secondary reproducing apparatus, according to an exemplary embodiment;

FIG. 9 shows a screen composition information file according to an exemplary embodiment;

FIG. 10 is a schematic diagram illustrating sorts of content that a primary reproducing apparatus may provide to a secondary reproducing apparatus, according to an exemplary embodiment;

FIG. 11 is a time mapping table according to an exemplary embodiment;

FIG. 12 is a block diagram illustrating streaming of additional content, according to an exemplary embodiment;

FIG. 13 is a block diagram for describing information about a primary reproducing apparatus that is provided to a secondary reproducing apparatus, according to an exemplary embodiment;

FIG. 14 is a schematic diagram illustrating a process of transmitting information about a primary reproducing apparatus to a secondary reproducing apparatus, according to an exemplary embodiment;

FIG. 15 is a flowchart of a reproducing method performed in a primary reproducing apparatus, according to an exemplary embodiment;

FIG. 16 is a flowchart of a reproducing method performed in a secondary reproducing apparatus, according to an exemplary embodiment;

FIG. 17 is a schematic diagram illustrating a communication process between a primary reproducing apparatus and a secondary reproducing apparatus according to an exemplary embodiment;

FIG. 18 illustrates a structure of an event according to an exemplary embodiment;

FIG. 19 is a block diagram illustrating a BD-ROM system model including a screen composition manager, according to an exemplary embodiment;

FIG. 20 is a block diagram illustrating processing of a generated event in a secondary reproducing apparatus, according to an exemplary embodiment;

FIG. 21 is a block diagram illustrating processing of a generated event in a primary reproducing apparatus, according to an exemplary embodiment;

FIG. 22 is a block diagram illustrating processing of a generated command in a secondary reproducing apparatus, according to an exemplary embodiment; and

FIG. 23 is a view illustrating a state register according to an exemplary embodiment.

### DETAILED DESCRIPTION OF EXEMPLARY EMBODIMENTS

Reference will now be made in detail to exemplary embodiments, which are illustrated in the accompanying drawings, wherein same reference numerals refer to the same elements throughout. In this regard, the exemplary embodiments may have different forms and should not be construed as being limited to the descriptions set forth herein. Accordingly, the exemplary embodiments are described below, by referring to the figures, to merely explain aspects of the disclosure. As used herein, the term “and/or” includes any and all combinations of one or more of the associated listed items. Expressions such as “at least one of,” when preceding a list of elements, modify the entire list of elements and do not modify the individual elements of the list.

Hereinafter, the terms used in the specification will be briefly described, and then the exemplary embodiments will be described in detail.

Although general terms widely used at present were selected for describing the exemplary embodiments in consideration of the functions thereof, these general terms may vary according to intentions of one of ordinary skill in the art, case precedents, the advent of new technologies, and the like. Some terms are arbitrarily selected to describe exemplary embodiments and their meanings will be explained in the detailed description of the related exemplary embodiments. Hence, terms must be defined in consideration of not only their general meanings but also the content of the entire specification.

The terms “comprises” and/or “comprising” or “includes” and/or “including” when used in this specification, specify the presence of stated elements, but do not preclude the presence or addition of one or more other elements. The terms “ . . . unit” and “ . . . module” when used in this specification refers to a unit in which at least one function or In operation is performed, and may be implemented as hardware, software, or a combination of hardware and software.

Embodiments of the exemplary embodiments are described in detail herein with reference to the accompanying drawings so that this disclosure may be easily understood by the ordinary skilled in the art. The exemplary embodiments may, however, be implemented in many different forms and should not be construed as being limited to a specific implementation set forth herein. In the drawings, some parts irrelevant to the description may not be explained for simplicity, and same numbers refer to same elements throughout the disclosure.

In the exemplary embodiments, an information storage medium for recording and distributing content or content-related information may be a Blue-ray disk, a DVD, a hard disk, a flash memory, a Universal Serial Bus (USB) memory, or the like, but is not limited thereto. Any type of storage media may be used instead as long as they are capable of recording data. For convenience of explanation, hereinafter, a disk is illustrated as an example of a storage medium that records content.

Hereinafter, a reproducing apparatus that plays back a disk will be referred to as a primary reproducing apparatus, and an apparatus having no capabilities of reproducing a disk or the content recorded thereon but having a screen will be referred to as a secondary reproducing apparatus. The secondary reproducing apparatus is capable of communicating with the primary reproducing apparatus via a network. For example, a portable phone, a PMP, a smart phone, and the like may be, but are not limited to, the secondary reproducing apparatus.

Data or information which is related to content to be reproduced by a primary reproducing apparatus and which is provided to a secondary reproducing apparatus, will be referred to as additional content. On the other hand, the content reproduced by the primary reproducing apparatus may also be referred to as main content. For example, the additional content may be, but is not limited to, additional information on the content, games or applications associated with the content, a result of decoding the content, or another content related to the content.

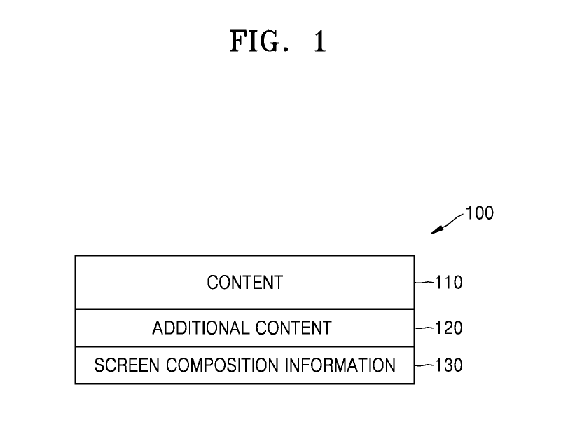

FIG. 1 is a block diagram for describing information that is recorded on an information storage medium according to an exemplary embodiment.

Referring to FIG. 1, content 110 that is reproduced by a primary reproducing apparatus, and additional content 120 associated with the content 110 may be recorded on a disk 100 of the primary reproducing apparatus. As described above, a type of the additional content 120 may or may not be same as the type of the content 110. The additional content 120 may include data associated with a service that is desired to be provided to a secondary reproducing apparatus in association with the content 110, such as a media file of a different type from the type of the content 110 to be reproduced together with the content 110, additional information about the content 110, games or applications associated with the content 110, shopping information associated with the content 110, and information for providing a Social Network Service (SNS) that is available while the content 110 is being reproduced.

The disk 100 may further include screen composition information 130 for providing the additional content 120 to the secondary reproducing apparatus. The screen composition information 130 describes information which is used in providing the additional content 120 to the secondary reproducing apparatus. If same additional content is provided to many secondary reproducing apparatuses or many users, the additional content may include single screen composition information. However, if additional contents are needed according to various scenarios required by a plurality of secondary reproducing apparatuses or a plurality of users, the additional contents according to various scenarios may include a plurality of pieces of screen composition information. The disk 100 may further include index information about the screen composition information 130.

A recording apparatus according to an exemplary embodiment includes a writer which writes data to the disk 100, and a controller which controls the writer to write data to the disk 100. The controller may control a writer to store, in the disk 100, content to be reproduced by a primary reproducing apparatus and/or screen composition information needed for providing additional content to a secondary reproducing apparatus. The additional content associated with the content may also be recorded on the disk 100.

A recording method according to an exemplary embodiment includes recording, on the disk 100, the content to be reproduced by the primary reproducing apparatus, and writing to the disk 100 the screen composition information for providing the additional content associated with the content to the secondary reproducing apparatus. The recording method according to an exemplary embodiment may further include recording the additional content associated with the content on the disk 100. The additional content associated with the content may also be recorded on the disk 100.

Additional content, screen composition information, and index information about the screen composition information that may be recorded on the disk 100 will now be described in detail.

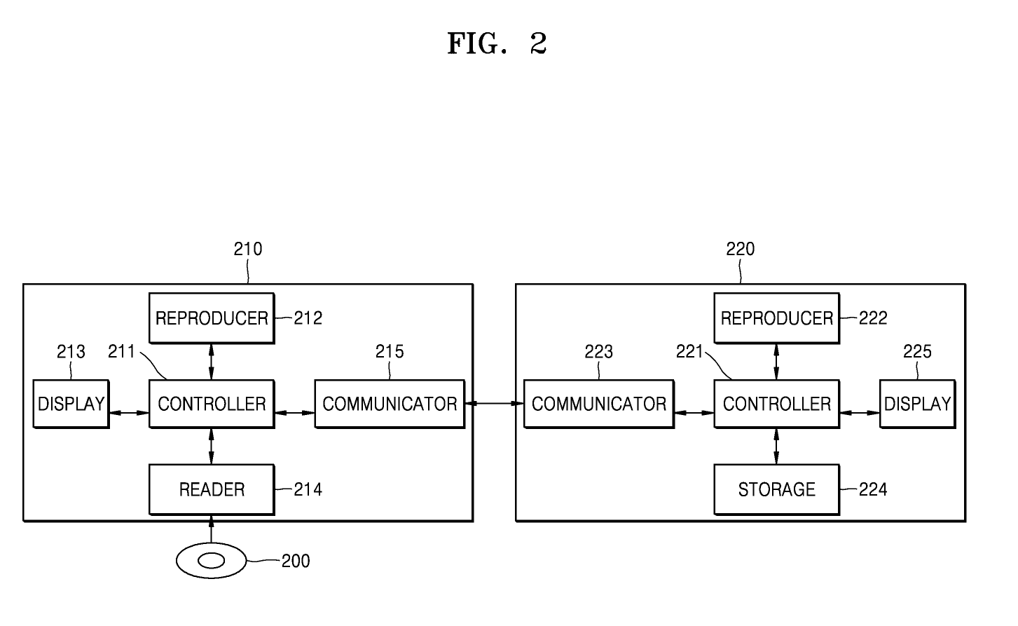

FIG. 2 is a block diagram illustrating a primary reproducing apparatus 210, a secondary reproducing apparatus 220, and a relationship between the two apparatuses 210 and 220, according to an exemplary embodiment.

Referring to FIG. 2, the primary reproducing apparatus 210 may include a reader 214 reading data from a disk 200, a communicator 215 communicating with the secondary reproducing apparatus 220, a reproducer 212 reproducing multimedia content recorded on the disk 200, a display 213 outputting reproduced content, and a controller 211 controlling these components to reproduce the multimedia content and provide additional content associated with the multimedia content to the secondary reproducing apparatus 220. The reader 214 reads content from the disk 200 and also screen composition information including information for providing the additional content associated with the content to the secondary reproducing apparatus 220 The controller 211 may transmit the screen composition information to the secondary reproducing apparatus 220 via the communicator 215 and provide the secondary reproducing apparatus 220 with additional content that is requested by the secondary reproducing apparatus 220 using the screen composition information. The communicator 215 is not limited to a specific type of communication device, and the communicator 215 may be implemented to support any communication protocol, such as Wi-Fi, a wireless local area network (LAN), infrared communication, Internet, Bluetooth, or a LAN.

The controller 211 may control the additional content to be reproduced by the secondary reproducing apparatus 220 while the content is reproduced by the primary reproducing apparatus 210, using the screen composition information. When a plurality of secondary reproducing apparatuses 220 request additional content, the controller 211 may control provision of information about a plurality of scenarios for providing different additional contents to the plurality of secondary reproducing apparatuses 220 via the screen composition information. The screen composition information may include one or more pieces of reproduction description information indicating how to obtain an additional content and/or how to reproduce an additional content. The reproduction description information is provided to the secondary reproducing apparatus 220 and is used to acquire and/or reproduce the additional content. The reproduction description information included in the screen composition information may further include at least one among information about an event necessary for reproducing the additional content, information about a method of arranging the additional content on a screen, information about when the reproduction description information is activated, and information about when the reproduction description information is deactivated. The controller 211 may selectively provide the reproduction description information to the secondary reproducing apparatus 220 according to the conditions of the secondary reproducing apparatus 220 or the conditions of a user of the secondary reproducing apparatus 220. In other words, reproduction description information may differ depending on the secondary reproducing apparatus 220 or the user of the secondary reproducing apparatus 220.

The controller 211 may synchronize reproduction of content by the reproducer 210 with reproduction of additional content by the secondary reproducing apparatus 220, using time mapping information included in the screen composition information. Index information about the screen composition information may be provided via the disk 200. The controller 211 may provide information on a location of the screen composition information and/or description information regarding the screen composition information to the secondary reproducing apparatus 220 by sending the index information to the secondary reproducing apparatus 220. The index information may further include at least one among information about a disk associated with the index information, information about additional content associated with the screen composition information, and information about the conditions of an apparatus or a user capable of accessing the screen composition information.

The primary reproducing apparatus 210 may further include a register for storing status information necessary for providing the additional content. The controller 211 may store in the register information indicating whether available screen composition information exists in a disk currently being played back, the number of secondary reproducing apparatuses 220 that are currently accessing the primary reproducing apparatus 210, the maximum number of secondary reproducing apparatuses 220 capable of simultaneously accessing the primary reproducing apparatus 210, and/or information for controlling an access to the primary reproducing apparatus 210, and use the same. The controller 211 may use the access control information stored in the register, in order to perform an authentication procedure with respect to the secondary reproducing apparatus 220 which requests for the additional content. For example, an authentication procedure may be performed on the secondary reproducing apparatus 220 or the user of the secondary reproducing apparatus 220, using a Personal Identification Number (PIN) stored in the register. Only when the secondary reproducing apparatus 220 or the user of the secondary reproducing apparatus 220 is authorized, the additional content may be provided to the secondary reproducing apparatus 220.

The secondary reproducing apparatus 220 may include a communicator 223 communicating with the primary reproducing apparatus 210, a reproducer 222 reproducing additional content, and a controller 221 controlling these components to receive the additional content from the primary reproducing apparatus 210, which reproduces content, and reproduce the received additional content. The controller 221 receives the screen composition information including the information for providing the additional content associated with the main content, which is reproduced by the primary reproducing apparatus 210, via the communicator 223, and requests the primary reproducing apparatus 210 for additional content selected using the screen composition information. The communicator 223 is not limited to a specific type of communication device, and the communicator 223 may be implemented to support any communication protocol, such as Wi-Fi, a wireless LAN, infrared communication, Internet, Bluetooth, or a LAN.

The controller 221 may reproduce the additional content in connection with content currently being reproduced by the primary reproducing apparatus 210, using the screen composition information received from the primary reproducing apparatus 210. Specifically, the controller 221 may acquire at least one reproduction description information indicating how to obtain the additional content and/or how to reproduce the additional content from the screen composition information, acquire the additional content by using the at least one reproduction description information and reproduce the additional content. The reproduction description information may further include information about an event necessary for reproducing the additional content, information about a method of arranging the additional content on a screen, time information about when the reproduction description information is activated and/or time information about when the reproduction description information is deactivated. The controller 221 may selectively provide the at least one reproduction description information received from the primary reproducing apparatus 210 to the user of the secondary reproducing apparatus 220 according to the conditions of the secondary reproducing apparatus 220 or the conditions of the user of the secondary reproducing apparatus 220. In detail, by referring to selection information of each of the at least one reproduction description information included in the screen composition information, the controller 221 outputs to a display 225 only reproduction description information of which selection information conforms to the conditions of the secondary reproducing apparatus 220 or the user of the secondary reproducing apparatus 220.

The controller 221 may synchronize reproduction of content by the primary reproducing apparatus 210 with reproduction of additional content by the reproducer 222, using time mapping information included in the screen composition information. The additional content may be received from the primary reproducing apparatus 210 or from an external server, and may include at least one among additional information about content that may be reproduced in association with the content which is reproduced by the primary reproducing apparatus 210, subtitle information about the main content, secondary video information of the main content, secondary audio information of the main content, and information about applications associated with the main content.

The controller 221 may receive the index information about the screen composition information from the primary reproducing apparatus 210 and use the received index information. The controller 221 may generate a graphical user interface (GUI) including information about a plurality of pieces of screen composition information using the index information and show the GUI to the user, thereby helping the user to select screen composition information. The received index information may comprise information indicating a location and/or description of the screen composition information The index information may further include at least one among information about a disk associated with the index information, information about additional content associated with the screen composition information, and information about the conditions of an apparatus or a user capable of accessing the screen composition information. The controller 221 may transmit authentication information of the secondary reproducing apparatus 220 or the user of the secondary reproducing apparatus 220 to the primary reproducing apparatus 210 and request the primary reproducing apparatus 210 to perform authentication regarding the secondary reproducing apparatus 220 or its user. If the authentication is successful, the controller 221 may receive and reproduce the additional content thereafter. A PIN, for example, may be used as the authentication information, but an exemplary embodiment of the authentication information is not limited thereto. The authentication procedure may be performed using other type of information.

The screen composition information is necessary for providing additional content associated with content that is reproduced by a primary reproducing apparatus to a secondary reproducing apparatus which communicates with the primary reproducing apparatus. The screen composition information may include a scenario describing, for example, when/what/how/in which direction/data regarding the additional content should be transmitted and received between the primary reproducing apparatus and the secondary reproducing apparatus. Information about a plurality of scenarios for providing different additional contents to a plurality of secondary reproducing apparatuses or to a plurality of users may be included in the screen composition information. The additional content is any content provided to and reproduced by the secondary reproducing apparatus in connection with the content reproduced by the primary reproducing apparatus, such as multimedia content, an additional image or video, additional information, or an additional service providing a game or an interactive function. The additional content may include any type of information.

A content manufacturer may use the screen composition information to define additional content that is reproduced or operated by at least one secondary reproducing apparatus in connection with content reproduced by the primary reproducing apparatus. In the conventional method, an additional image or video or an additional service such as a game may be processed only by a primary reproducing apparatus which reproduces the disk. According to an exemplary embodiment, however, a content manufacturer may provide various types of additional content not only to a primary reproducing apparatus reproducing a disk but also to various secondary reproducing apparatuses possessed by a disk purchaser, using the screen composition information.

The screen composition information is recorded on the disk together with main content, and may be provided by a content manufacturer. A primary reproducing apparatus that supports screen composition information may acquire the screen composition information provided by the content manufacturer from the disk. When a user inserts the disk manufactured and distributed by the content manufacturer into the primary reproducing apparatus, the primary reproducing apparatus may acquire the screen composition information from a predetermined location on the disk. The location on the disk where the screen composition information is stored may be designated in accordance with standards relating to the disk. For example, when the disk is a Blu-ray disk, the location on the disk where the screen composition information is stored may be designated according to the Blue-ray playback standards. The type and shape of data included in the screen composition information, the name of a file storing the screen composition information, and the types and the number of files that constitute the screen composition information may also be defined.

A location where additional content which is to be reproduced or operated by the secondary reproducing apparatus via the screen composition information is to be recorded may be predefined according to the standards associated with a storage medium or a reproducing apparatus that is used.

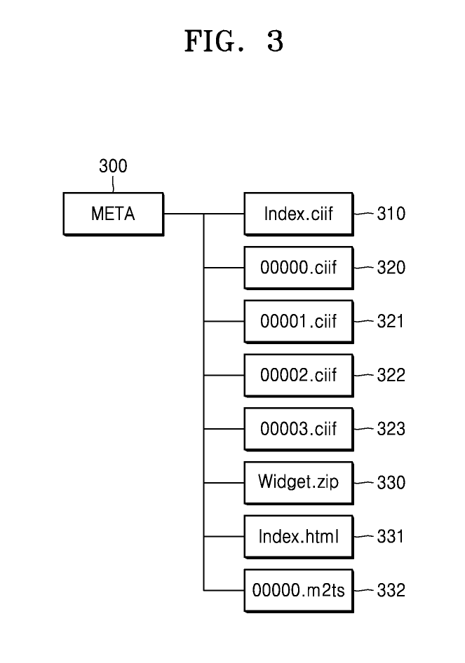

FIG. 3 is a block diagram for explaining screen composition information recorded in a directory within a Blu-ray disk according to an exemplary embodiment.

The Blu-ray disk records content to have a directory structure, and a META directory 300 stores metadata files of the Blu-ray disk. Referring to FIG. 3, the screen composition information may include a plurality of screen composition information files 320, 321, 322, and 323, namely, 00000.ciif, 00001.ciif, 00002.ciif, and 00003.ciif, within the META directory 300, and a screen composition information index file 310, namely, Index.ciif, including index information about the plurality of screen composition information files. In the screen composition information files 320-323, different scenarios for providing additional content to a secondary reproducing apparatus may be described. In the screen composition information index file 310, information about each of the screen composition information files 320-323 and detailed locations thereof may be recorded.

Referring to FIG. 3, Widget.zip 330, Index.html 331, and 00000.m2ts 332, as files for providing additional content that is reproduced or operated by the secondary reproducing apparatus via the screen composition information, may be recorded in the META directory 300. Widget.zip 330 is a compression of files that are necessary for executing a widget to be provided to the secondary reproducing apparatus, Index.html 331 is a Hypertext Markup Language (HTML) file describing additional information to be provided to the secondary reproducing apparatus, and 00000.m2ts 332 is a file in which a video stream to be provided to the secondary reproducing apparatus is recorded. These additional contents may be reproduced or executed in line with content that is reproduced by a primary reproducing apparatus, and information necessary for interoperating the additional content with the content may be described in the screen composition information files 320-323 and/or the screen composition information index file 310.

The names and storage locations of the above-described files are only examples and may be described in different ways in other exemplary embodiments.

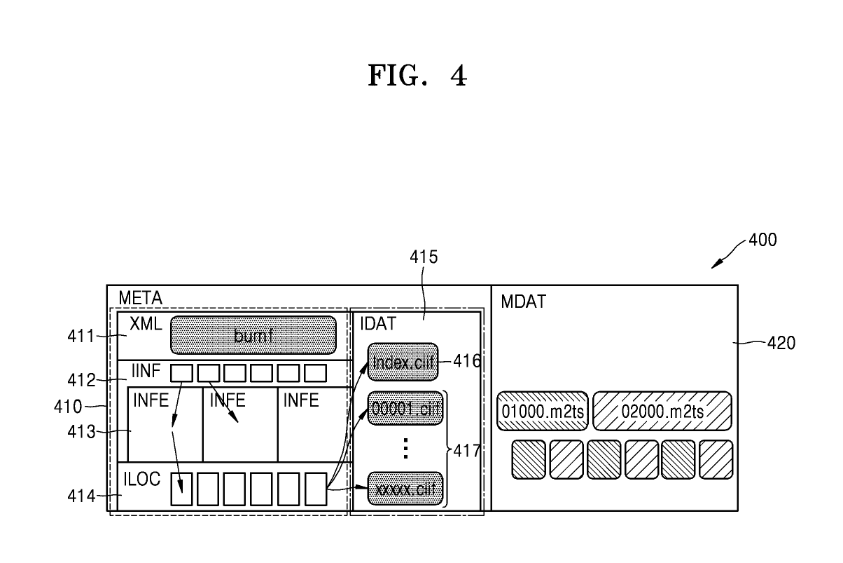

FIG. 4 is a block diagram for explaining an arrangement of screen composition information associated with content distributed as one file within the file, according to an exemplary embodiment.

Complying to ISO/IEC 14496-12 ISO base media File Format (ISOFF), a plurality of files are recorded to form a bit stream in a single file. In other words, a stream file, a metadata file, and the like are stored in a single file. As illustrated in FIG. 4, all reproduction-related files recorded on a conventional disk and media content form a single file which will now be referred to as a disk image file. A plurality of disk image files may exist in a large-capacity storage medium such as a high-capacity optical disk, a hard disk, or a flash memory.

Referring to FIG. 4, a disk image file 400 includes a META box 410 for recording metadata, and a MDAT box 420 for recording data such as an audio-visual (AV) stream.

The META box 410 is configured to have a hierarchical structure, and includes several types of boxes in a lower level. The META box 410 may include an IINF box 412 including INFE boxes 413 for recording identifiers and names of component files that constitute content, and an ILOC box 414 for recording information about locations of the component files within an ISOFF file. A primary reproducing apparatus may locate stream files and screen composition information, by referring to the IINF box 412 and the ILOC box 414. In the example of FIG. 4, a screen composition information index file 416 and a plurality of screen composition information files 417 are recorded in an IDAT box 415, and data such as the stream files is recorded in the MDAT box 420.

The META box 410 may include an eXtensible Markup Language (XML) box 411 for recording a Binding Unit Manifest File (BUMF) that defines a virtual package in which content read from a disk is combined with content downloaded from an external source and stored in a local storage. The Binding Unit Manifest File is used by a virtual file system which generates a virtual package and controls an access to files of the virtual package. The Binding Unit Manifest File includes a definition of a combination of files that are bound together with management information for a binding operation.

According to the embodiment illustrated in FIG. 4, the primary reproducing apparatus may access the screen composition information including the screen composition information index file 416 and the screen composition information files 417, using location information of a file recorded on a front portion of the disk image file 400, namely, on the META box 410.

A content manufacturer may provide a service to users with via different scenarios depending on genders, ages, interests, tastes, and the like of the users, by providing a plurality of screen composition information files in association with a single disk or a single disk image. A single screen composition information file may correspond to a single scenario. The screen composition information may be accessed in different ways.

For example, assuming that the screen composition information file exists in a predetermined location, a reproducing apparatus may read and process the screen composition information file existing under a predetermined folder. The screen composition information file may be implemented to have a predefined file extension (in the embodiment of FIG. 3, the file extension is ciif), and the reproducing apparatus may recognize all files having the predefined certain extensions.

Alternatively, the screen composition information file may be accessed using a screen composition information index file. FIGS. 3 and 4 illustrate an example in which the files 310 and 416, each named with Index.ciif, are screen composition information index files. When a screen composition information index file is used, a screen composition information file may not need to exist on a disk or disk image having content recorded thereon, and may not need to be recorded on a predetermined location. The content manufacturer may describe, in the screen composition information index file, locations of screen composition information files that may be provided by a corresponding disk. When the reproducing apparatus accesses a screen composition information index file recorded on a predetermined location and processes information recorded on the screen composition information index file, the reproducing apparatus is able to access all related screen composition information files.

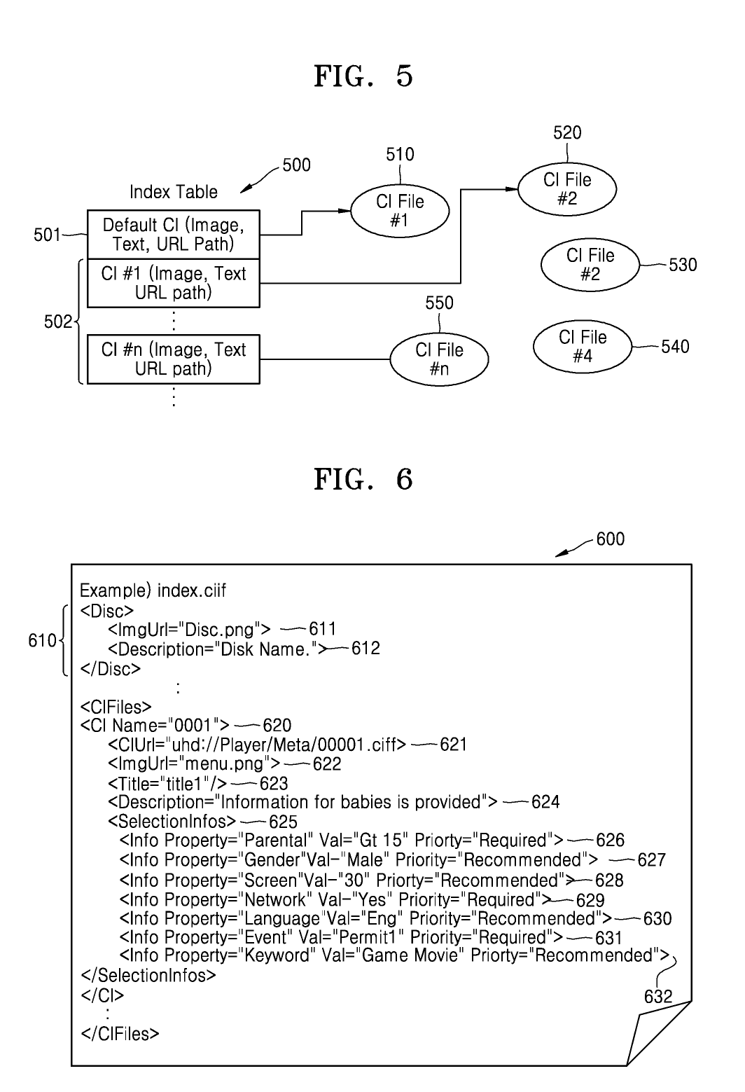

FIG. 5 is a schematic diagram for explaining a method of accessing screen composition information files using a screen composition information index, according to an exemplary embodiment.

The screen composition information index file may exist on a predetermined location, and a reproducing apparatus that supports screen composition information files may access a plurality of screen composition information files associated with a disk via the screen composition information index. A screen composition information index may be implemented using a file described in a language such as the XML, but embodiments of the exemplary embodiments are not limited thereto. The screen composition information index may be implemented using information in a binary form, a table form, or any other form. As in FIG. 4, when the single disk image file 400 is provided by combining all folders and files within a disk with each other, the screen composition information index file 416 may be recorded in a bit string form within the disk image file 400.

Referring to FIG. 5, one screen composition information index 500 may exist per disk or disk image, and may include user interface (UI) information that is used in displaying screen composition information about additional content that may be provided to a secondary reproducing apparatus and enabling a user to select desired additional content. Items 501 and 502 of the screen composition information index 500 are UI information, and may include an image and/or text information that describe screen composition information files 510-550. The items 501 and 502 of the screen composition information index 500 may include pieces of information that respectively indicate respective locations of the screen composition information files 510-550. Uniform resource locator (URL) information may be used as the pieces of location information of the screen composition information files 510-550.

Referring to FIG. 5, the screen composition information index 500 includes a default item 501. The default item 501 includes reference information to the default screen composition information file 510 including a default scenario of a service provided to a secondary reproducing apparatus that accesses the screen composition information index 500. In this case, the screen composition information file 510 may describe additional content that may be provided regardless of the status or condition of the secondary reproducing apparatus or a user. The screen composition information index 500 may also include reference information to the screen composition information files 520-550 in which scenarios of additional content that may be selectively provided based on the status or condition of the secondary reproducing apparatus or its user. For example, screen composition information describing a scenario of a content service for babies, screen composition information describing a scenario of a content service for adults, and screen composition information describing a scenario of a content service for women may be included in different screen composition information files.

FIG. 6 shows a file in which a screen composition information index is stored, according to an exemplary embodiment. A screen composition information index file 600 may include at least one of the following pieces of information.

(1) A Location of a Screen Composition Information File

The screen composition information index file may include URL information as location information of each screen composition information file. The URL information may include a path of a screen composition information file existing in a disk, or include a path of a screen composition information file existing outside the disk, for example, in a local storage of a reproducing apparatus or an external server. Referring to FIG. 6, location information of a screen composition information file ‘00001.ciff’ is expressed using a <CIUrl> tag 621.

(2) Information about a Related Disk

The information about a related disk indicates which disk or disk image the screen composition information index file is associated with. The information about a related disk is used to indicate a disk, with which a screen composition information index file currently being provided to a secondary reproducing apparatus is associated with, on a display of the secondary reproducing apparatus via a GUI or the like. The information about a related disk may include a representative image and a description of the disk. Referring to FIG. 6, information 610 about a disk is described between <Disc> tags. A path of an image file, an audio file, and/or a video file for a disk description, which is defined by a <ImgUrl> tag 611, and a description text that is defined by a <Description> tag 612 may be included for describing the related disk.

(3) Additional Description Information about a Screen Composition Information File

When a plurality of screen composition information files are associated with a disk played back by a primary reproducing apparatus, a secondary reproducing apparatus needs to know in advance which information or service is to be provided via the plurality of screen composition information files. When such information is not provided to a user of the secondary reproducing apparatus, the user may waste time finding a screen composition information file suitable for the user. Thus, the screen composition information index file may include information about each screen composition information file so that the user may select a desired screen composition information file. In other words, the screen composition information index file may include information explaining each of the screen composition information files described in the screen composition information index file to the user. Referring to FIG. 6, as description information about a screen composition information file, location of an image file representing a service corresponding to the screen composition information file is described by the <ImageUrl> tag 622 within a <CI> tag 620. A text indicating a service corresponding to the screen composition information file is described by a <Description> tag 623 within the <CI> tag 620. A title associated with the screen composition information file may be described using a <Title> tag 623 within the <CI> tag 622. The additional description information about the screen composition information file is not limited to the above-described information, and may be provided via various media such as moving picture data or audio data.

(4) Information for Selectively Providing Screen Composition Information Based on the Users of Secondary Reproducing Apparatuses

A secondary reproducing apparatus may acquire all pieces of screen composition information file information associated with a disk of a primary reproducing apparatus by receiving a screen composition information index file from the primary reproducing apparatus. However, in some cases, it may not be appropriate to show the same screen composition information to all secondary reproducing apparatuses or to all users of the secondary reproducing apparatuses and allow the secondary reproducing apparatuses or the users to select desired screen composition information. For example, when a user of a secondary reproducing apparatus does not match a parental level of additional content that is provided via screen composition information, the user should be prevented from accessing the screen composition information.

Referring to FIG. 6, the screen composition information index file 600 includes selection information that uses a <SelectionInfos> tag 625, in order to selectively provide screen composition information based on qualifying conditions or a request of the user of the secondary reproducing apparatus and/or based on the status of the primary reproducing apparatus or the secondary reproducing apparatus. For example, when a parental level is set as ‘15 years old or over’ for specific screen composition information and the user of the secondary reproducing apparatus is under 15, the secondary reproducing apparatus needs to prevent the user from accessing the specific screen composition information. In order to control such a user access, the following information may be inserted using <SelectionInfos> tag 625 within <CI> tag 620 covering the screen composition information file:

<Info Property=“Parental” Val=“Gt 15” Priority=“Required”>

In the above, it is indicated that the screen composition information is limited with a parental level ‘Gt 15’, and further a value ‘Required’ indicates that this access limitation is essential.

Similarly, in the screen composition information index file 600, an access authority or restriction of a user for each screen composition information file may be set. At least one of the following pieces of information may be used to define an access authority or restriction.

\textcircled{1} Parental level information 626: As described above, the parental level information 626 is used to limit an access to a screen composition information file based on user's age. When user's age set in a secondary reproducing apparatus conforms to the parental level information 626, the user is allowed to access the screen composition information file. Otherwise, the user is blocked from accessing the screen composition information file. To block the user access, information about the screen composition information file may not be displayed on a screen of the secondary reproducing apparatus.

\textcircled{2} Region information: The region information is used to limit an access to a screen composition information file based on a nation or a region of the user, or a region associated with the primary reproducing apparatus. When information about a nation or a region set in the secondary reproducing apparatus and/or the primary reproducing apparatus conforms to the region information set in a screen composition information index file, the user may be allowed to access the screen composition information file. Otherwise, the user may be blocked from accessing the screen composition information file.

\textcircled{3} Nation information: The nation information is used to limit an access to a screen composition information file according to the nation of the user. When the nation of a user set in the secondary reproducing apparatus conforms to the nation information set in a screen composition information index file, the user may be allowed to access the screen composition information file. Otherwise, the user may be blocked from accessing the screen composition information file.

\textcircled{4} Gender information 627: The gender information 627 is used to limit an access to a screen composition information file according to whether a user is male or female. When a gender of a user set in the secondary reproducing apparatus conforms to gender information set in a screen composition information index file, the user may be allowed to access the screen composition information file. Otherwise, the user may be blocked from accessing the screen composition information file.

\textcircled{5} Information 631 about a specific event that occurs in a primary reproducing apparatus or a secondary reproducing apparatus: The information 631 is used to limit an access to a screen composition information file based on whether a certain event has occurred in the primary reproducing apparatus or the secondary reproducing apparatus. When an event that has occurred in the primary reproducing apparatus or the secondary reproducing apparatus conforms to event information set in a screen composition information index file, the user may be allowed to access the screen composition information file. Otherwise, the user may be blocked from accessing the screen composition information file. A content manufacturer may control content associated with a disk of the primary reproducing apparatus to be activated in the secondary reproducing apparatus at only a specific time point, using the even information 631.

\textcircled{6} Information 630 about a language that is used: The information 630 is used to limit an access to a screen composition information file according to a language that is used. When a to-be-used language set in the secondary reproducing apparatus conforms to a to-be-used language condition set in a screen composition information index file, the user may be allowed to access the screen composition information file. Otherwise, the user may be blocked from accessing the screen composition information file.

\textcircled{7} Keyword information 632: The keyword information 632 is used to limit an access to a screen composition information file according to keyword information registered in the secondary reproducing apparatus. When a user registers a keyword of interest in the secondary reproducing apparatus, the secondary reproducing apparatus may compare a keyword recorded in a screen composition information index file with the keyword registered by the user and show only screen composition information that matches with the keyword of interest of the user. In the example of FIG. 6, since keyword information ‘Game Movie’ is defined for the screen composition information named with ‘00001’, a corresponding screen composition information file may be provided to the user who registered a keyword of interest ‘Game Movie.

(5) A Description of the Specifications of a Secondary Reproducing Apparatus that is Suitable for Processing a Screen Composition Information File

In some cases, screen composition information may not be suitable for reproduction due to a display resolution of a secondary reproducing apparatus or a lack of network connectivity of the secondary reproducing apparatus For example, when a media file described in a screen composition information file may be accessed only via a network and the secondary reproducing apparatus does not support a networking function, accesses to the screen composition information file are not necessary. In this case, to prevent a user from unnecessarily accessing a screen composition information file, a required specifications of a secondary reproducing apparatus to reproduce each screen composition information file may be described. Information about the required specifications of the secondary reproducing apparatus may include, but is not limited to, at least one of the following pieces of information. The information about the required specifications of the secondary reproducing apparatus may include other types of information indicating the specifications or status of the secondary reproducing apparatus.

\textcircled{1} Screen size and resolution 628: Information about a screen size and/or a resolution that are suitable for reproducing additional content that is provided via screen composition information may be defined in a screen composition information index file. When a screen size and/or a resolution of a secondary reproducing apparatus conforms to a screen size and/or a resolution set in a screen composition information index file, a user of the secondary reproducing apparatus may be allowed to access the screen composition information file. Otherwise, the user may be blocked from accessing the screen composition information file.

\textcircled{2} Information 629 indicating whether a networking function is supported: The information 629 is used to define whether a secondary reproducing apparatus needs to support a networking function in order to receive additional content corresponding to screen composition information. When network specifications of the secondary reproducing apparatus conform to network information corresponding to screen composition information, the user may be allowed to access a corresponding screen composition information file. Otherwise, the user may be blocked from accessing the corresponding screen composition information file.

\textcircled{3} A restriction on hardware such as decoder performance: A restriction on hardware such as the performance of an included decoder may be defined in addition to screen specifications and network specifications necessary for receiving the additional content corresponding to the screen composition information.

(6) Priority of Selection Information

A secondary reproducing apparatus may provide a user with a UI screen configured with optimal screen composition information based on the screen composition information index file received from a primary reproducing apparatus. The optimal screen composition information may be selected using the information described above: (4) the information for selectively providing screen composition information according to users of secondary reproducing apparatuses and the description and (5) the information of the specifications of a secondary reproducing apparatus that is suitable for processing a screen composition information file. Additionally, a priority may be set for the selection information items 626-632 defined within the <SelectionInfos> tag 625. In detail, when it is determined whether a condition corresponding to each of the selection information items 626-632 is satisfied, a priority indicating, for example, that the condition is required to be satisfied, that the condition is recommended to be satisfied, or that the condition is a simple keyword for searching, may be set for each of the selection information items 626-632. Different priorities may be set for an item that is required to be checked, like the parental level information 626, and for an item that is not necessarily required for reproduction, like the screen item 628.

The content manufacturer may set priorities of the selection information items 626-632 when manufacturing the screen composition information index file 600, and the secondary reproducing apparatus may provide the user with suitable screen composition information in consideration of the set priorities. Referring to FIG. 6, priorities are set for the selection information items 626-632 using a ‘Priority’ attribute. When a value of the ‘Priority’ attribute is ‘Required’ as in the parental level item 626, a condition corresponding to the parental level information 626 is required to be considered. When the value of an ‘Priority’ attribute is ‘Recommended’, a corresponding condition is recommended to be considered. When the secondary reproducing apparatus or the user of the secondary reproducing apparatus does not satisfy a limitation that the value of the ‘Priority’ attribute is ‘Required’, corresponding screen composition information may not be shown to the user so that the user is blocked from using corresponding additional content. When the secondary reproducing apparatus or the user of the secondary reproducing apparatus does not satisfy a limitation that the value of the ‘Priority’ attribute is ‘Recommended’, corresponding screen composition information may be shown to the user so that the user determines whether to use corresponding additional content.

(7) Information about Whether a Screen Composition Information Index File is Allowed to be Copied

The information about whether the screen composition information index file is allowed to be copied is used when the content manufacturer sets whether to allow or not allow the screen composition information index file to be copied into the secondary reproducing apparatus. When it is set that copying of the screen composition information index file into the secondary reproducing apparatus is allowed, the secondary reproducing apparatus may store a received screen composition information index file in a local storage thereof. When copying of the screen composition information index file into the secondary reproducing apparatus is allowed, the secondary reproducing apparatus may store the screen composition information index file on a location that may be identified by a certain module of the secondary reproducing apparatus that receives and processes a screen composition information index file, a screen composition information file, and additional content. When it is set that copying of the screen composition information index file into the secondary reproducing apparatus is not allowed, the secondary reproducing apparatus may be prohibited from storing the screen composition information index file in the local storage thereof. Each screen composition information file that is accessible via the screen composition information index file may be set in regard to whether the screen composition information file is allowed to be copied into the secondary reproducing apparatus. The information about whether a screen composition information index file is allowed to be copied may be described within the screen composition information index file. For example, a phrase of <FileCopy=“Allowed”> or <FileCopy=“Not Allowed”> may be used to set whether the screen composition information index file is allowed to be copied.

As described above, the screen composition information index file may provide a combination of pieces of selection information for each screen composition information file. In the example of FIG. 6, an age, a gender, a used language, a nationality, a screen size, and whether a network is supported are described as selection information between <SelectionInfos> tag 625 and </SelectionInfos> tag.

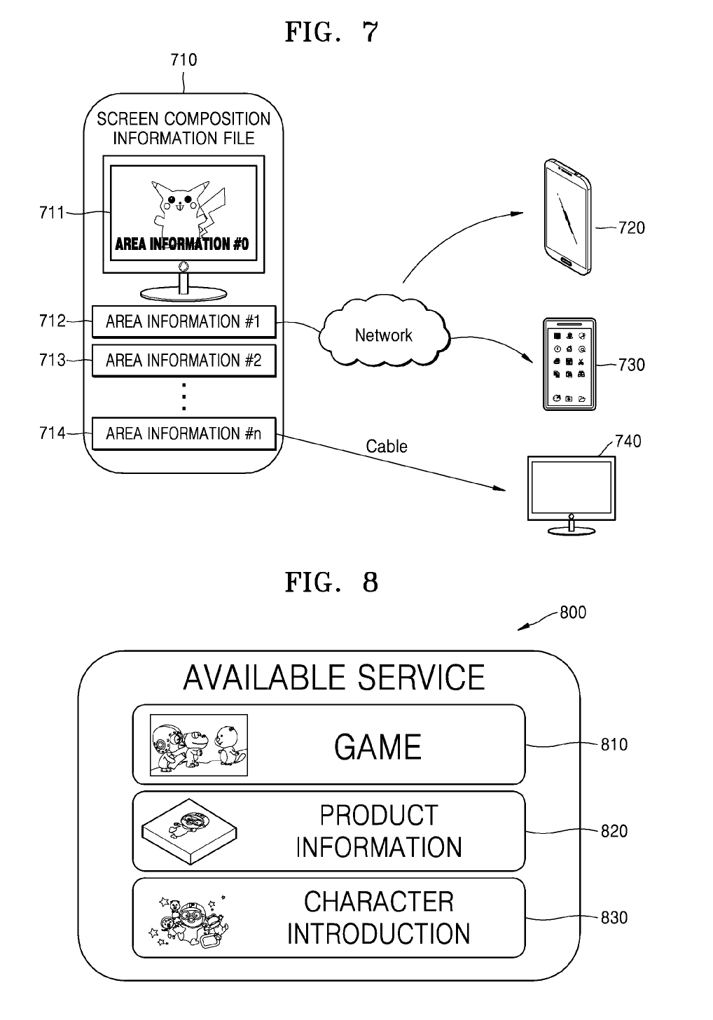

FIG. 7 is a schematic diagram for describing a structure of a screen composition information file according to an exemplary embodiment.

Referring to FIG. 7, a screen composition information file 710 may include a plurality of pieces of area information 711-714. The plurality of pieces of area information 711-714 define areas for providing information to a primary reproducing apparatus and/or a secondary reproducing apparatus. Referring to FIG. 7, the primary reproducing apparatus reproduces content based on the area information #0 711, two secondary reproducing apparatuses 720 and 730 acquire the contents specified in the area information #1 712 from the primary reproducing apparatus via a network and use the acquired contents, and a secondary reproducing apparatus 740 acquires the contents specified in the area information #n 714 from the primary reproducing apparatus via a cable network and use the acquired contents. The area information #0 used by the primary reproducing apparatus may be regarding a main area, and the area information #1 through #n used by the secondary reproducing apparatuses may be regarding hidden areas that are not shown by the primary reproducing apparatus. In contrast, the plurality of pieces of area information #0 through #n may be set as non-hidden areas. In this case, an output screen of the primary reproducing apparatus may be divided into a plurality of areas, and a result generated according to each of the plurality of pieces of area information #0 through #n may be displayed on each of the plurality of areas. Area information will be hereinafter referred to as reproduction description information.

FIG. 8 illustrates screen composition information that is displayed by a secondary reproducing apparatus, according to an exemplary embodiment. The secondary reproducing apparatus may display a plurality of pieces of reproduction description information included in one piece of screen composition information as shown in FIG. 8. When the plurality of pieces of reproduction description information are recorded in the screen composition information, various types of detailed content may be provided. For example, when a user of a secondary reproducing apparatus selects a screen composition information file for babies from among a plurality of pieces of screen composition information, the user may be provided additional content for babies in various forms or in various scenarios.

Referring to FIG. 8, available additional content 800 associated with content that is reproduced by a primary reproducing apparatus may include a game 810 associated with the main content, product information 820 associated with the main content, and a character introduction 830 associated with the main content. Each of the menu items 810, 820, and 830 may correspond to each reproduction description information recorded within a screen composition information file, and may be generated from an image and text information included in each reproduction description information. As such, each reproduction description information may include information such as an image, a text, and a video representing the reproduction description information. When content, e.g., a movie, is reproduced by a primary reproducing apparatus, it is desirable that certain information to help to enjoy the main content, such as, an audio dubbed for babies or a subtitle, is also provided. The information may be described by the reproduction description information.

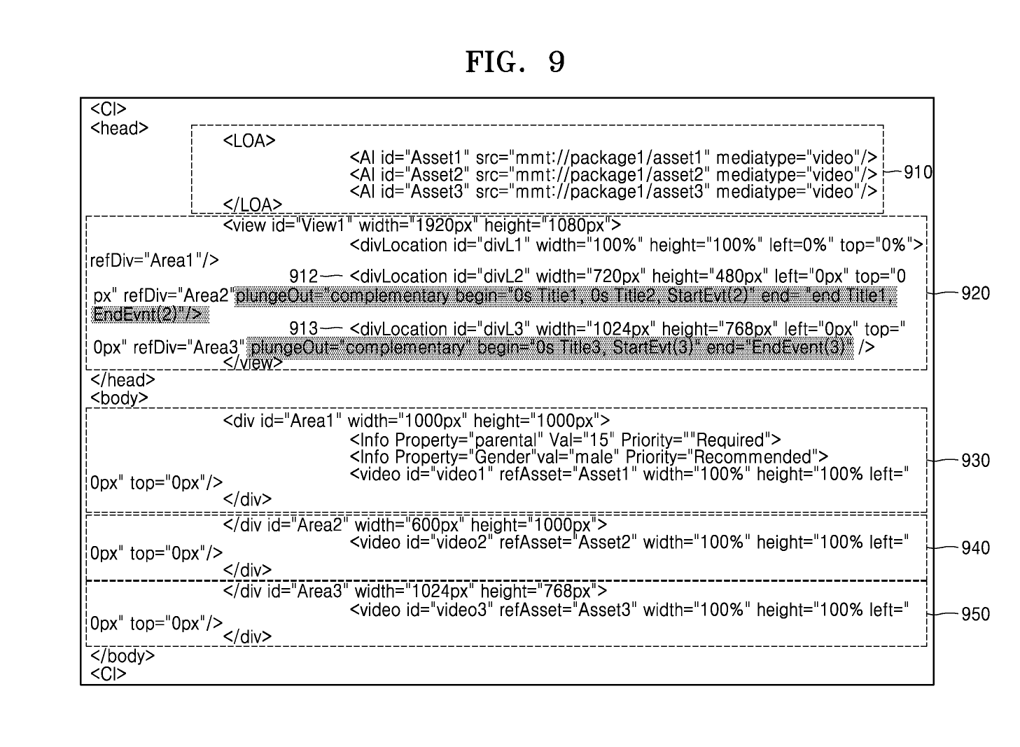

FIG. 9 shows a screen composition information file according to an exemplary embodiment. In FIG. 9, the screen composition information file is implemented in the XML. However, the screen composition information file may be implemented in other languages such as the HTML or in other structures such as a binary form.

The screen composition information file may include at least one reproduction description information. The reproduction description information describes information about additional content that is to be reproduced on a screen that is a display of a secondary reproducing apparatus. Referring to FIG. 9, the screen composition information file includes three pieces of reproduction description information 930, 940, and 950, each of which exists between a <div> tag and a </div> tag and has ‘Area1’, ‘Area2’, or ‘Area3’ as an identifier thereof. The reproduction description information is information about a screen image and multimedia data that are actually provided to a user, and may be configured with a combination of the following pieces of information.

(1) Media Path Information

The reproduction description information may include media path information that describes a path for a location of additional content corresponding to the reproduction description information. A method of accessing the corresponding additional content may be determined using the media path information. The media path information may be described using an URL. The media path information may be described for all files existing on locations accessible by the secondary reproducing apparatus.

(2) Reproduction-Related Information

The reproduction description information may include information about a receiving method and/or a reproducing method in order to smoothly reproduce additional content that exists on a location indicated by the media path information. In detail, the reproduction description information may include reproduction-related information such as a media compression format, a file providing method, a communication protocol, and the form of content. The file providing method indicates whether corresponding additional content is provided as a compressed file or a decompressed image. The communication protocol is a protocol that is to be used to receive the corresponding additional content, and indicates a communication method such as a Hyper Text Transfer Protocol (HTTP), a File Transfer Protocol (FTP), or a Real-time Transfer Protocol (RTP). The form of content is information representing the type of additional content, such as a video, an audio, or a text.

(3) Arrangement Information of Each Content

The reproduction description information may include arrangement information about in what ratio or size the corresponding additional content needs to be reproduced on the screen of the secondary reproducing apparatus.

(4) Information about an Event that is Used

The reproduction description information may include information about an event necessary for reproducing the corresponding additional content in order to smoothly process an event that occurs in the primary reproducing apparatus.

The screen composition information file may include description information about each reproduction description information in order to help a user to select one among multiple pieces of reproduction description information. The description information may include information about a location of an image or AV data capable of representing each reproduction description information, and a description text. The information about the location may be implemented in a URL form including the location of the image and/or the AV data and access information. The secondary reproducing apparatus may acquire an image, text and/or AV data via a network or via other communication methods using the information about the location and generate a menu on which a plurality of pieces of reproduction description information are enumerated using the acquired image, text and/or AV data and the description text. The description information about the reproduction description information may be recorded using an <ImgUrl> tag including location information about a description image and a <Description> tag including a description text, in the plurality of pieces of reproduction description information 930, 940, and 950 between the <div> tag and the </div> tag or in reproduction description information 920 between the <view> tag and the </view> tag.

The screen composition information file may include information about when each reproduction description information is activated and/or deactivated. All pieces of reproduction description information may not always be used by the secondary reproducing apparatus When content that is to be reproduced by the primary reproducing apparatus is provided via a disk, reproduction description information which is to be shown to a user may vary depending on a location or a time regarding the playback of the content, an event that occurs, or the like. For example, while the first title of the disk is being reproduced by the primary reproducing apparatus, it is appropriate to show only the reproduction description information for the first title to a user. Hence, when each reproduction description information is to be activated, and when each reproduction description information is to be deactivated need to be set properly. Reproduction description information activated may be provided to a user of the secondary reproducing apparatus, and reproduction description information deactivated may not be provided to the user of the secondary reproducing apparatus.

When reproduction description information is activated and/or deactivated may be defined based on an event that occurs in the primary reproducing apparatus. In this case, the event information may be transmitted from the primary reproducing apparatus to the secondary reproducing apparatus, and the secondary reproducing apparatus may activate or deactivate each reproduction description information based on the received event information and provide the activated or deactivated reproduction description information to the user. When the reproduction description information is activated or deactivated may be described by a combination of the following events, but the exemplary embodiments are not limited thereto and may be described by other events that may occur in the primary reproducing apparatus. When the reproduction description information is activated or deactivated may be determined based on events that occurred in the primary reproducing apparatus. For example, any combination of the following events using a logical operator such as, OR and/or AND may affect activation or deactivation of the reproduction description information.

\textcircled{1} A disk insert event and a disk eject event

\textcircled{2} An event of starting or ending of a specific title

\textcircled{3} An event according to a reproduction status change in a specific playlist such as, a reproduction start, a reproduction end, a current reproducing time, a reproduction rate change, or reproduction failure

\textcircled{4} A system time event

\textcircled{5} An event according to a state change in an application of a disk, such as end, start, pause, resume, or the like of the application

\textcircled{6} An event that occurs in an application of a disk

\textcircled{7} An event by an operation of a user

\textcircled{8} An event according to a resource state of a primary reproducing apparatus, such as deficiency of processing resources for a new secondary reproducing apparatus or reproduction failure

\textcircled{9} An event according to a state change in reproduction description information, such as an event indicating that available reproduction description information has been activated at a certain time point or via activation of an application, or an event indicating that reproduction description information being currently used became unable to be used

\textcircled{10} Other events

A combination of various events and/or operations may be defined as a custom event, which is a user-defined event, and then may be used. Reproduction description information may be described to be activated or deactivated in correspondence with the custom event. The reproduction description information may be defined to be activated or deactivated a certain time period (a system time period or a media time period) after a certain event is received.

Referring to FIG. 9, when corresponding reproduction description information is activated and deactivated are respectively defined using attributes ‘begin’ and ‘end’ of <divLocation> tags 912 and 913, and when the reproduction description information is activated and deactivated are defined by a combination of events. Whether the corresponding reproduction description information may be sent to another apparatus may be described using an attribute ‘plungeOut’.

If events necessary for processing the reproduction description information are defined in a front portion or other portions of the screen composition information file, a screen composition manager may register the defined events in an event listener and quickly manage the defined events. For example, all events needed by the screen composition information file of FIG. 9 may be described in the screen composition information file using a <EventList> tag. Referring back to FIG. 2, the screen composition manager may be a module included in the controller 211 of the primary reproducing apparatus 210, because the screen composition manager performs all processes for providing additional content to the secondary reproducing apparatus. If the controller 211 includes a module dedicated to process events, the module may perform management, such as registration of an event and transmission of event information.

The screen composition information file may include information about a path and related attributes of content that is to be reproduced via reproduction description information. Referring to FIG. 9, a path, an attribute, and the like for additional content to be reproduced via the reproduction description information are described in a portion 910 between a <LoA> tag and a </LoA> tag. To quickly check additional content on the corresponding screen composition information, a reproduction processing module of a secondary reproducing apparatus needs path information and attribute information of the additional content. Referring to FIG. 9, additional content that is reproduced with reference to the plurality of pieces of reproduction description information ‘Area1’, ‘Area2’, and ‘Area3’ (930, 940, and 950) is described using <Al> tags respectively identified with identifiers ‘Asset1’, ‘Asset2’, and ‘Asset3’ in the portion 910 using the <LoA> tag. In each of the <Al> tags, path information of the additional content and type information as an attribute of the additional content are described. The type of additional content to be reproduced is shown as video here, but it is not limited thereto, and may be an audio, a widget, a web document, an application, or the like. The secondary reproducing apparatus may quickly determine whether the secondary reproducing apparatus is able to support corresponding additional content, by referring to media type information corresponding to reproduction description information.

The screen composition information file may include information for selectively sending the reproduction description information to the secondary reproducing apparatus. The information may be described as selection information, as in a screen composition information index file. The reproduction description information may be prohibited or allowed, depending on status or conditions of a user and/or the secondary reproducing apparatus, such as, age, nation, gender of the user, network connectivity, or the size of a reproducing screen. The secondary reproducing apparatus may show suitable information to the user using selection information set for reproduction description information and based on the priority. Referring to FIG. 9, a parental value is set as ‘15’ in the first reproduction description information 930 and a priority is displayed as ‘Required’ therein, so the first reproduction description information 930 may be provided only to users who are 15 years old or over, and this parental selection information is required to be considered. When a priority is displayed as ‘Recommended’, this selection information may be referred to but does not have to be considered. Whether to consider selection information displayed as ‘Recommended’ may be determined according to internal setting of the secondary reproducing apparatus or the user's choice.

The screen composition information file may include information about an item that needs to be downloaded in advance. When additional content described via screen composition information includes large data, the data needs to be downloaded in advance in order to be smoothly provided to the user at any desired time. Therefore, data to be downloaded in advance from among additional content described in the screen composition information may be indicated in the screen composition information. Further, the reproduction description information may indicate whether some of additional content need to be pre-loaded into a memory or a buffer of the primary reproducing apparatus, and/or whether some of the necessary additional content need to be pre-loaded into a memory or a buffer of the secondary reproducing apparatus.

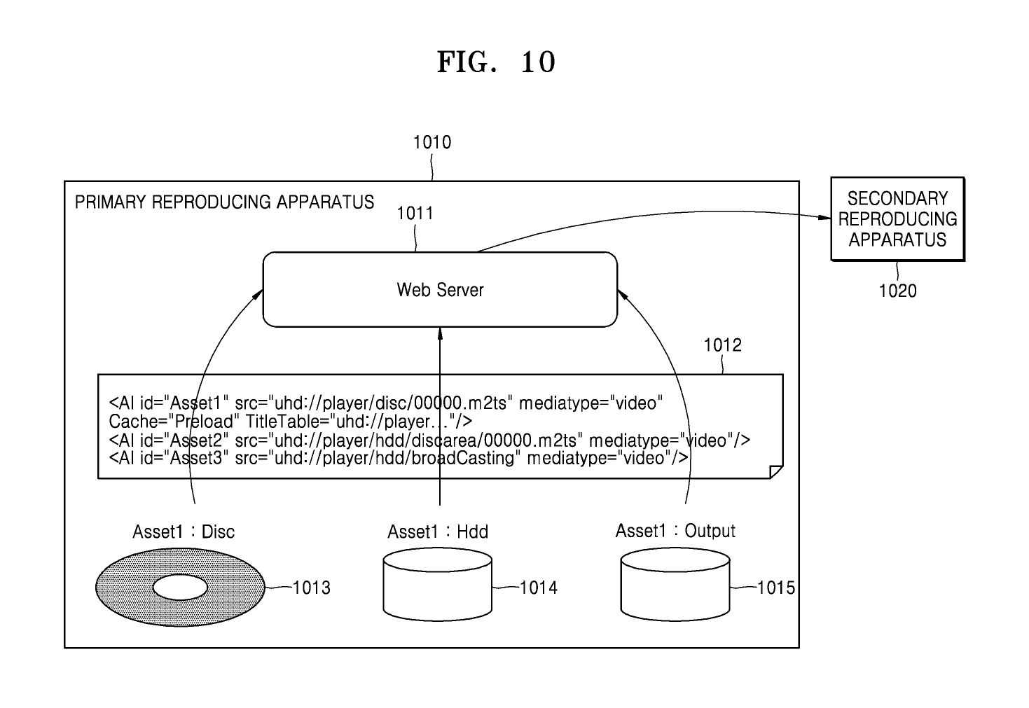

FIG. 10 is a schematic diagram for explaining sorts of content that a primary reproducing apparatus may provide to a secondary reproducing apparatus, according to an exemplary embodiment.

Referring to FIG. 10, a secondary reproducing apparatus 1020 acquires additional content via a network. A primary reproducing apparatus 1010 may provide the additional content to the secondary reproducing apparatus 1020. In reproduction description information included in screen composition information provided by the primary reproducing apparatus 1010, additional content that may be provided by the primary reproducing apparatus 1010 is described. The secondary reproducing apparatus 1020 acquires the additional content described in the reproduction description information from the primary reproducing apparatus 1010 via the network and reproduces the acquired additional content. The additional content may be acquired not only from the primary reproducing apparatus 1010, which provides the screen composition information, but also from any server that may be accessed via the network.

Referring to FIG. 10, the primary reproducing apparatus 1010 transmits the additional content to the secondary reproducing apparatus 1020 via a web server 1011, and screen composition information 1012 describes, as available additional content, 00000.m2ts recorded on a disk 1013, 00000.m2ts recorded on a hard disk 1014, and broadcasting information that is reproduced and output by the primary reproducing apparatus 1010.

Additional content that may be provided by the primary reproducing apparatus 1010 to the secondary reproducing apparatus 1020 is illustrated below.

(1) Additional content recorded on the disk 1013 of the primary reproducing apparatus 1010

Audio data, video data, subtitle data, widget data, and the like recorded on the disk 1013 may be provided to the secondary reproducing apparatus 1020. Referring back to FIG. 3, additional content for only the secondary reproducing apparatus 1020, such as widget data Widget.zip (330), HTML content Index.html (331), and stream data 00000.m2ts (332), may be recorded as separate files.

(2) Additional content downloaded in a local storage of the disk 1013 via a network by an application of the disk 1013

When the primary reproducing apparatus 1010 executes the application of the disk 1013, media data downloaded by the application from an external server and stored in a readable/writable area such as the hard disk 1014 may be provided to the secondary reproducing apparatus 1020.

(3) An image output to a screen of the primary reproducing apparatus 1010

An image that is decoded by the primary reproducing apparatus 1010 and is currently being displayed on the screen may be broadcast to the secondary reproducing apparatus 1020. In this case, content being reproduced by the primary reproducing apparatus 1010 may also be reproduced by the secondary reproducing apparatus 1020.

(4) Image information or audio information that is multiplexed into a single file together with an image currently being reproduced by the primary reproducing apparatus 1010

While the primary reproducing apparatus 1010 is reproducing content recorded on a disk, an additional image, audio, or data recorded on the same file as the content may be provided to the secondary reproducing apparatus 1020. Since the additional image, the audio, or the data have been recorded in the same file, the additional image, the audio, and the data may be transmitted to the secondary reproducing apparatus 1020 without an excessive location change or search by a reader of the primary reproducing apparatus 1010. For example, secondary video and secondary audio which are multiplexed into a main video on a Blu-ray disk may be decoded and provided to the secondary reproducing apparatus 1020, without an excessive change in a reading location by a reader of the primary reproducing apparatus 1010.

A content manufacturer may describe whether each additional content may be copied into a secondary reproducing apparatus, within screen composition information or reproduction description information. Additional content specified as being allowed to be copied may be copied by the secondary reproducing apparatus. The screen composition information may include information about whether a plurality of pieces of additional content need to be sequentially transmitted to the secondary reproducing apparatus.

When media stored on a disk of a primary reproducing apparatus is reproduced by a plurality of secondary reproducing apparatuses, excessive seeking of a loader occurs, thereby causing a performance degradation. Thus, via a description included in the reproduction description information, specific additional content may be designated to be always stored in cache memory of the primary reproducing apparatus. In other words, by setting an attribute for the additional content as “needs to be cached”, the primary reproducing apparatus may store a portion of corresponding media or the entire media in a cache memory thereof. When an attribute for additional content is defined as “need to be cached”, the primary reproducing apparatus needs to store a part or all of a corresponding file in the cache memory thereof. An attribute regarding whether to cache data may be expressed as “Cache=“Preload” TitleTable=“uhd://player . . . ”.

When additional content that is reproduced by the secondary reproducing apparatus needs to be reproduced in synchronization with content reproduction time of the primary reproducing apparatus or with a system time of the primary reproducing apparatus, a mapping table may be used to map the content reproduction time or the system time of the primary reproducing apparatus with a reproduction time of the secondary reproducing apparatus. The mapping table may include information for mapping content reproduction time with additional content reproduction time, based on a time when the primary reproducing apparatus transmitted the additional content. Using the time mapping table, synchronization between the primary reproducing apparatus and the secondary reproducing apparatus may be achieved even when a time flow of the primary reproducing apparatus is different from that of the secondary reproducing apparatus. The time mapping table may be described using additional attributes associated with the additional content in the screen composition information or the reproduction description information. When the time mapping table is long, it may be stored in a separate file and the screen composition information or the reproduction description information may include URL information for the file.

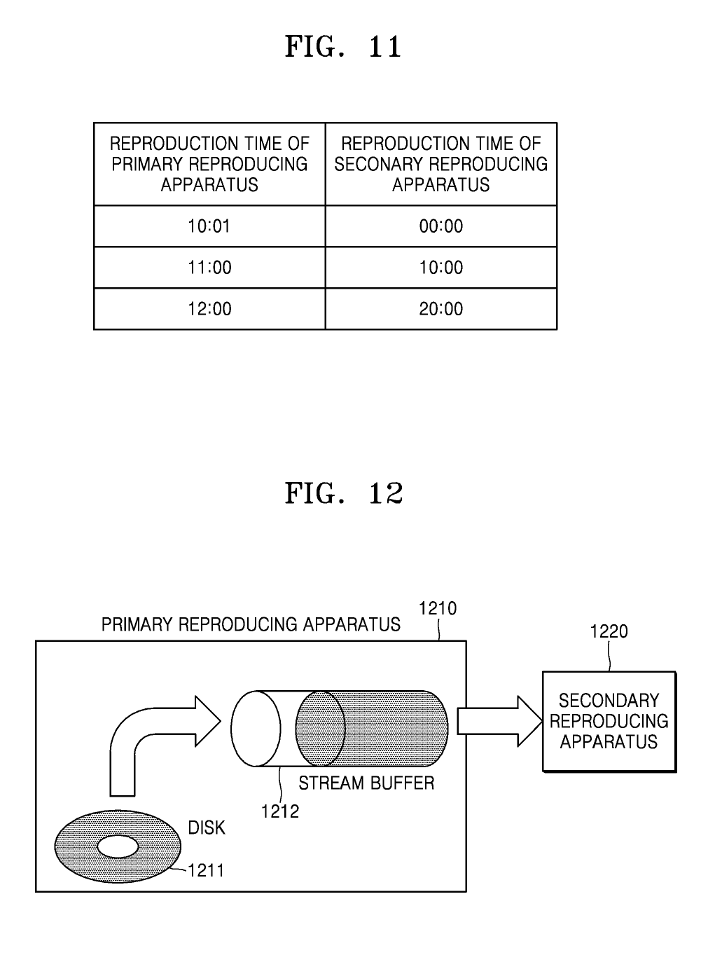

FIG. 11 is a time mapping table according to an exemplary embodiment.

Referring to FIG. 11, when a content reproduction time in primary reproducing apparatus is 11:00, a secondary reproducing apparatus needs to start reproducing additional content from 10:00. When the time mapping table is used, even the case where a time flow of the primary reproducing apparatus is different from that of the secondary reproducing apparatus may be properly handled.

The secondary reproducing apparatus may store additional content downloaded via a network in a cache memory or in a local storage for later use. By maintaining information that maps URL information of the additional content with a path on the local storage, the secondary reproducing apparatus may not have to download the data again when the same additional content is needed later.

FIG. 12 is a block diagram for explaining streaming of additional content, according to an exemplary embodiment.

Referring to FIG. 12, a primary reproducing apparatus 1210 may employ a sequential transmission method when a media file corresponding to additional content that is to be provided to a secondary reproducing apparatus 1220 is large. A screen composition manager of the primary reproducing apparatus 1210 includes a stream buffer 1212 for sequential transmission, and stores data read from a disk 1211 or a hard disk (not shown) in the stream buffer 1212 and then sequentially transmits the read data to the secondary reproducing apparatus 1220 that has requested the primary reproducing apparatus 1210 to transmit the data. Screen composition information may include information about whether to sequentially transmit read data, as a reproduction media attribute for the additional content. The primary reproducing apparatus 1210 sequentially sends files designated to be sequentially transmitted, and the secondary reproducing apparatus 1220 sequentially receives and reproduces the files.

A secondary reproducing apparatus needs to select a primary reproducing apparatus on a network in order to use a service associated with the content from a primary reproducing apparatus when a plurality of primary reproducing apparatuses are capable of providing the service to the secondary reproducing apparatus. The secondary reproducing apparatus receives apparatus description information from the plurality of primary reproducing apparatuses and selects one from among the plurality of primary reproducing apparatuses based on the received apparatus description information. When a plurality of storage media are associated with a content service that may be provided by a primary reproducing apparatus, the secondary reproducing apparatus may receive information about the storage media, and select one from among the storage media using the received information. The selection of a primary reproducing apparatus or storage medium may be performed by a user via a UI, and information that is provided to the user to select a primary reproducing apparatus or storage medium may include information describing the primary reproducing apparatus and information for describing additional content associated with each of the storage media.

When a primary reproducing apparatus possesses a disk capable of providing screen composition information and may provide a service associated with the disk, the primary reproducing apparatus transmits information about the primary reproducing apparatus to the secondary reproducing apparatus, together with a response to an inquiry about whether the service may be provided, which is received from the secondary reproducing apparatus. In the primary reproducing apparatus, a screen composition manager that manages information transmission and reception with the secondary reproducing apparatus may perform the above transmission. information about the primary reproducing apparatus may include at least one of the following.

(1) Apparatus information about the primary reproducing apparatus, which includes at least one among image information, video information, and text information may be sent. The apparatus information about the primary reproducing apparatus may be registered by a user of the primary reproducing apparatus.

(2) Information about a possessor of the primary reproducing apparatus, which includes at least one among image information, video information, and text information may be sent. The information about the possessor of the primary reproducing apparatus may be registered by the user of the primary reproducing apparatus.

(3) Description information about a disk and/or a disk image possessed by the primary reproducing apparatus and capable of providing an associated service may be sent. The primary reproducing apparatus may include a storage medium such as, an optical disk, a hard disk, or a flash memory, and a storage medium having a plurality of disk images may exist. The primary reproducing apparatus may provide description information about a plurality of disk images or disks, and the secondary reproducing apparatus may generate a menu screen image enabling selection of a desired disk image or disk using the description information and provide the menu screen image to a user. The user selects a desired disk image or disk on the menu screen image and is provided with additional content associated with the selected desired disk image or disk.

Description information about a disk image or a disk may include a combination of at least one of the following pieces of information.

\textcircled{1} Image information and/or text information describing a disk or a disk image

\textcircled{2} Information about a location of the disk or the disk image on the primary reproducing apparatus

\textcircled{3} Information indicating that no disk images exist in the primary reproducing apparatus and only a screen composition information index file and a screen composition information file exist in the primary reproducing apparatus

\textcircled{4} Information about a location of the screen composition information index file corresponding to the disk or the disk image

Location information used to access the screen composition information index file associated with the disk or the disk image may be described in the URL form. When the screen composition information index file associated with the disk or the disk image does not exist and only one screen composition information file is associated with the disk or the disk image, path information of the screen composition information file may be described instead.

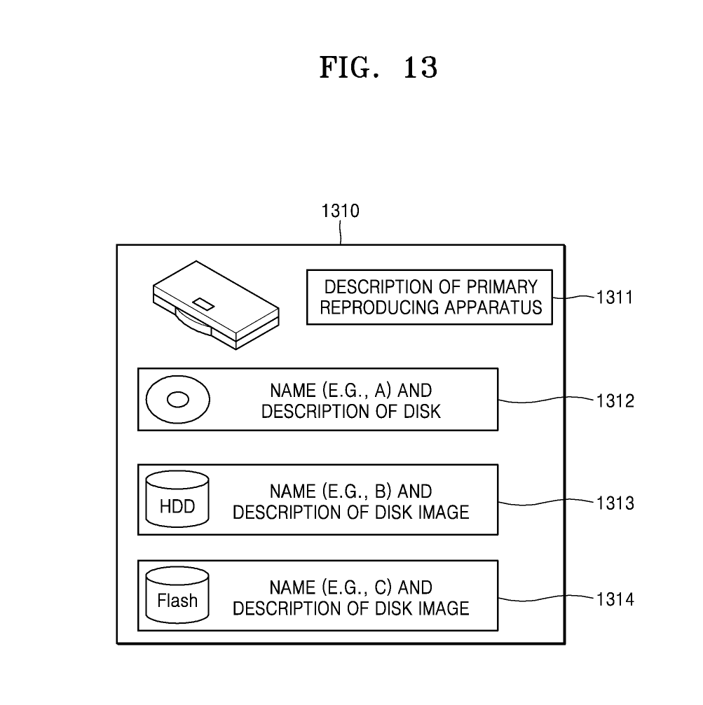

FIG. 13 is a block diagram for describing information about a primary reproducing apparatus that is provided to a secondary reproducing apparatus, according to an exemplary embodiment. The information about the primary reproducing apparatus may include information about the primary reproducing apparatus and information about disks and disk images included in the primary reproducing apparatus, and may be transmitted to the secondary reproducing apparatus via a screen composition manager of the primary reproducing apparatus. Referring to FIG. 13, name and/or description 1311 of the primary reproducing apparatus and names and/or descriptions 1312, 1313, 1314 of disks and disk images of the primary reproducing apparatus may be displayed on a screen of the secondary reproducing apparatus using the received information about the primary reproducing apparatus. FIG. 13 shows that the primary reproducing apparatus may provide the secondary reproducing apparatus with additional content associated with a disk A, a disk image B existing in a hard disk, or a disk image C existing in a flash memory.

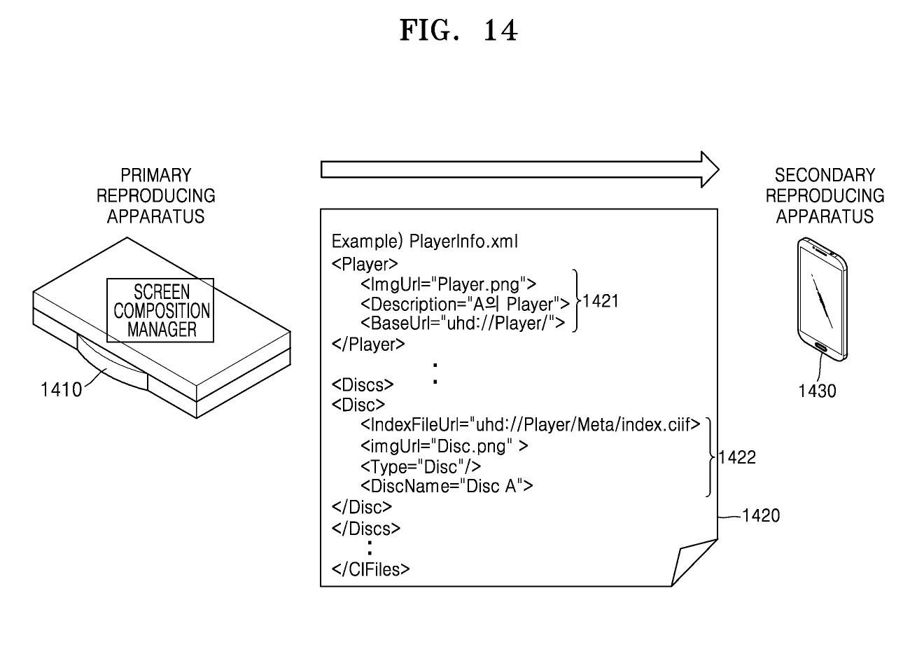

FIG. 14 is a schematic diagram for explaining a process of transmitting information about a primary reproducing apparatus to a secondary reproducing apparatus, according to an exemplary embodiment. Although an information file 1420 about a primary reproducing apparatus 1410 is written in the XML in FIG. 14, the information file 1420 may be implemented in any other languages or forms.

Referring to FIG. 14, information about the primary reproducing apparatus 1410 is described in a portion 1421 between a <Player> tag and a </Player> tag, and information about all disks and disk images of the primary reproducing apparatus 1410 is described in a portion 1422 between a <Discs> tag and a </Discs> tag. As to the information about the primary reproducing apparatus 1410, a <BaseUrl> tag and a <ImgUrl> tag for describing a path and a file name of image information are used, and a <Description> tag for describing text information is used. Information about each of a disk and a disk image of the primary reproducing apparatus 1410 is interposed between a <Disc> tag and a </Disc> tag. As can be seen from FIG. 14, an <IndexFileUrl> tag for describing a path of an associated screen composition information index file, an <ImgUrl> tag for describing a path of image information about a disk or a disk image, a <Type> tag for describing the type of the disk or the disk image, and a <DiscName> tag for describing the name of the disk or the disk image are included between the <Disc> tag and the </Disc> tag. A secondary reproducing apparatus 1430 may receive the information file PlayerInfo.xml (1420) having the information about the primary reproducing apparatus 1410 recorded therein, generate a UI screen image similar to that illustrated in FIG. 13, and display the UI screen image.

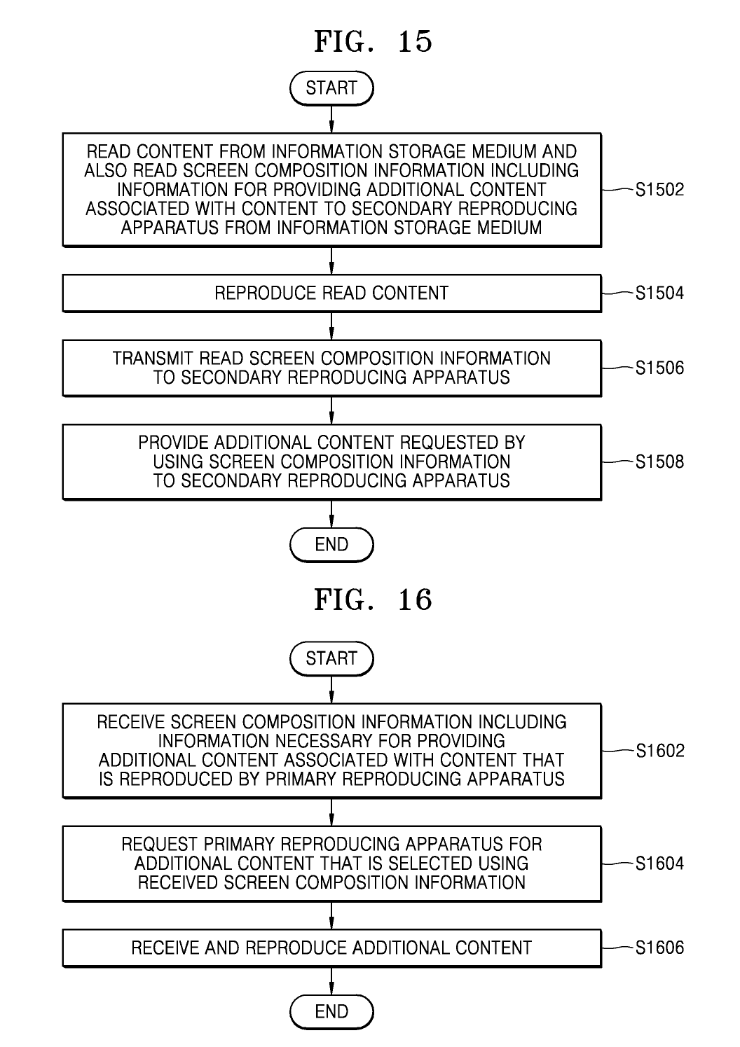

FIG. 15 is a flowchart of a reproducing method performed in a primary reproducing apparatus, according to an exemplary embodiment.

Referring to FIG. 15, in operation S1502, the primary reproducing apparatus reads content from an information storage medium and also reads screen composition information including information for providing additional content associated with the content to a secondary reproducing apparatus from the information storage medium. In operation S1504, the content is reproduced by the primary reproducing apparatus. In operation S1506, the screen composition information is transmitted to the secondary reproducing apparatus. The secondary reproducing apparatus determines additional content which is to be reproduced by the secondary reproducing apparatus, by referring to the received screen composition information, and requests the primary reproducing apparatus for the determined additional content. In operation S1508, the primary reproducing apparatus provides the additional content requested by the secondary reproducing apparatus to the secondary reproducing apparatus.

FIG. 16 is a flowchart of a reproducing method performed in a secondary reproducing apparatus, according to an exemplary embodiment.

Referring to FIG. 16, in operation S1602, the secondary reproducing apparatus receives screen composition information from a primary reproducing apparatus. The screen composition information includes information necessary for providing the secondary reproducing apparatus with additional content associated with content reproduced by the primary reproducing apparatus. In operation S1604, the secondary reproducing apparatus selects desired additional content using the received screen composition information and requests the primary reproducing apparatus for the selected additional content. In operation S1606, when the secondary reproducing apparatus receives the additional content from the primary reproducing apparatus, the secondary reproducing apparatus reproduces the additional content.

According to an exemplary embodiment, a basic policy for performing communication is that the primary reproducing apparatus does not manage the state of information that is provided to the secondary reproducing apparatus. In other words, managing the state of selected screen composition information file or selected reproduction description information is a role of the secondary reproducing apparatus. When further information is needed for the secondary reproducing apparatus to perform this role, the secondary reproducing apparatus may request the primary reproducing apparatus or a screen composition manager of the primary reproducing apparatus for the necessary information.

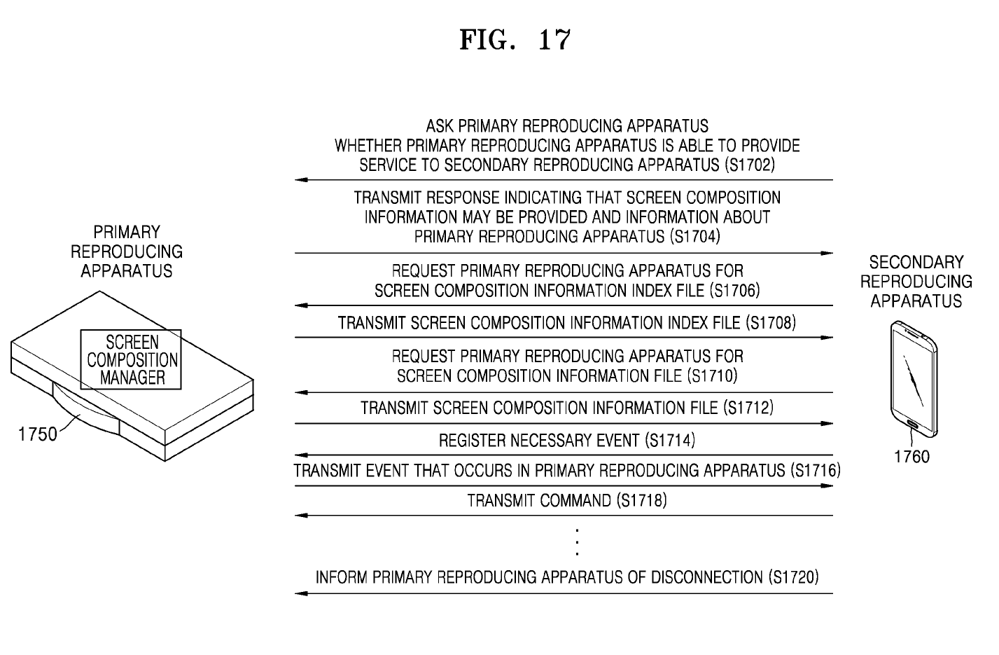

FIG. 17 is a schematic diagram for explaining a communication process between a primary reproducing apparatus and a secondary reproducing apparatus according to an exemplary embodiment. FIG. 17 illustrates a signal flow of communication between the primary reproducing apparatus and the secondary reproducing apparatus.

The primary reproducing apparatus and the secondary reproducing apparatus may transmit or receive information necessary for reproducing additional content, via the communication process illustrated in FIG. 17. In FIG. 17, an arrow (→) indicates a direction in which information or a request travels. For example, when “the secondary reproducing apparatus→the primary reproducing apparatus” is illustrated, this means that a request or information is transmitted from the secondary reproducing apparatus to the primary reproducing apparatus. A screen composition manager of the primary reproducing apparatus may manage communication with the secondary reproducing apparatus.

In operation S1702, a secondary reproducing apparatus 1760 asks a primary reproducing apparatus 1750 whether the primary reproducing apparatus 1750 is able to provide a service to the secondary reproducing apparatus 1760. The inquiry about whether the primary reproducing apparatus 1750 is able to provide a service to the secondary reproducing apparatus 1760 may include an inquiry about whether screen composition information may be provided and a request for information. The secondary reproducing apparatus 1760 may send an inquiry to a plurality of primary reproducing apparatuses 1750 in order to obtain a list of primary reproducing apparatuses 1750 on a network capable of providing additional content to the secondary reproducing apparatus 1760.

In operation S1704, the primary reproducing apparatus 1750 transmits, to the secondary reproducing apparatus 1760, a response indicating that screen composition information may be provided and information about the primary reproducing apparatus 1750, in order to inform the secondary reproducing apparatus 1760 that the primary reproducing apparatus 1750 is able to provide a service. In operation S1706, the secondary reproducing apparatus 1760 allows a user to select a desired disk or disk image using the received information about the primary reproducing apparatus 1750, and requests the primary reproducing apparatus 1750 for a screen composition information index file associated with the selected desired disk or disk image. The secondary reproducing apparatus 1760 may acquire URL information of the screen composition information index file associated with the selected desired disk or disk image from the information about the primary reproducing apparatus 1750 received in operation S1704, and request the primary reproducing apparatus 1750 for the screen composition information index file by transmitting the acquired URL information to the primary reproducing apparatus 1750. In operation S1708, the primary reproducing apparatus 1750 transmits the screen composition information index file requested by the secondary reproducing apparatus 1760 to the secondary reproducing apparatus 1760. If the information about the primary reproducing apparatus 1750 includes only information about a screen composition information file, operations S1706 and S1708 may be omitted.

In operation S1710, the secondary reproducing apparatus 1760 selects a screen composition information file desired by the user, based on the received screen composition information index file, and requests the primary reproducing apparatus 1750 for the selected screen composition information file, based on path information of the screen composition information file that is included in the screen composition information index file. When the path information of the screen composition information file indicates a location other than a location of the primary reproducing apparatus 1750, a request for the screen composition information file may be sent via a network corresponding to the path information. In operation S1712, the primary reproducing apparatus 1750 transmits the screen composition information file to the secondary reproducing apparatus 1760. The secondary reproducing apparatus 1760 may acquire a path of data necessary for reproducing additional content desired by the user, using reproduction description information of the received screen composition information file, receive the data from the path, and reproduce the data. When the received screen composition information file includes a plurality of pieces of reproduction description information, the secondary reproducing apparatus 1760 may enable the user to select desired reproduction description information from among the plurality of pieces of reproduction description information and request for additional content corresponding to the selected reproduction description information.

To activate or deactivate the reproduction description information, the secondary reproducing apparatus 1760 may need to receive an event that occurs in the primary reproducing apparatus 1750. When the secondary reproducing apparatus 1760 reproduces additional content associated with the reproduction description information, the secondary reproducing apparatus 1760 may also need the event occurring in the primary reproducing apparatus 1750. In this case, in operation S1714, the secondary reproducing apparatus 1760 may register the necessary event in the primary reproducing apparatus 1750. In operation S1716, when the registered event has occurred, the secondary reproducing apparatus 1760 may receive event information from the primary reproducing apparatus 1750.

The primary reproducing apparatus 1750 may send event information to the secondary reproducing apparatus 1760 according to any of the following methods.

(1) A Method for the Primary Reproducing Apparatus 1750 to Transmit Information about Only Necessary Events to the Secondary Reproducing Apparatus 1760

To use this method, the primary reproducing apparatus 1750 needs to know what event is needed by the secondary reproducing apparatus 1760. The primary reproducing apparatus 1750 may acquire a list of events needed by the secondary reproducing apparatus 1760 by referring to the screen composition information file sent to the secondary reproducing apparatus 1760. In this case, the event list is described in the screen composition information file. Alternatively, the secondary reproducing apparatus 1760 may send the event list to the primary reproducing apparatus 1750. Here, the secondary reproducing apparatus 1760 may transmit URL information of the secondary reproducing apparatus 1760 with the event list, so that the primary reproducing apparatus 1750 may be able to send to the secondary reproducing apparatus 1760 event information corresponding to an event designated in the event list. These two methods are only different in terms of a subject that requests for event generation information. However, in both methods, the event list and the URL information of the secondary reproducing apparatus 1760 may be maintained by the screen composition manager of the primary reproducing apparatus 1750.

(2) A Method for the Primary Reproducing Apparatus 1750 Sends Event Information Corresponding all Events to all Secondary Reproducing Apparatuses 1760 Connected to a Network

According this method, the primary reproducing apparatus 1750 sends all events to all secondary reproducing apparatuses 1760 connected to a network, and each of the secondary reproducing apparatuses 1760 accepts and process only necessary event information.

Receiving the event information from the primary reproducing apparatus, the secondary reproducing apparatus 1760 performs an operation corresponding to the event, such as, controlling reproduction of additional content according to the received event or activating or deactivating the reproduction description information. In operation S1718, a command input by a user of the secondary reproducing apparatus 1760 may be transmitted to the primary reproducing apparatus 1750. An event that has occurred in the secondary reproducing apparatus 1760 may also be transmitted to the primary reproducing apparatus 1750. By transmitting the event information or the command, the primary reproducing apparatus 1750 may be controlled via the secondary reproducing apparatus 1760.

In operation S1720, when the secondary reproducing apparatus 1760 no longer uses a service provided by the primary reproducing apparatus 1760, the secondary reproducing apparatus 1760 sends to the primary reproducing apparatus 1750 a disconnection notification. In response to the disconnection notification, the primary reproducing apparatus 1750 stops sending event information to the secondary reproducing apparatus 1750.

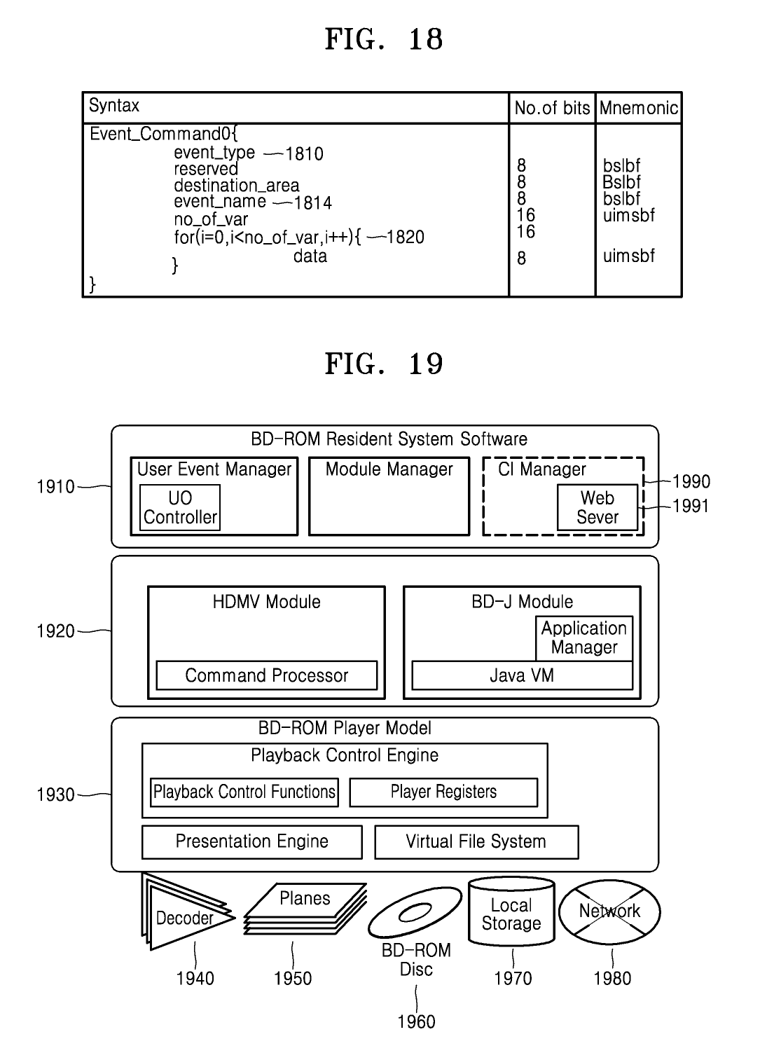

FIG. 18 illustrates a structure of event information according to an exemplary embodiment. A secondary reproducing apparatus and a primary reproducing apparatus may perform bidirectional communication using the event information. FIG. 18 illustrates event information generated by the primary reproducing apparatus or the secondary reproducing apparatus.

Referring to FIG. 18, the event information may include information 1810 about an event type. The event type indicates a category of the event. Different types of events may include a synchronization event, a media event, a disk event, a disk event, a title event, a user operation event, an error event, and the like.

The synchronization event is synchronized reproduction of content by the primary reproducing apparatus with reproduction of additional content by the secondary reproducing apparatus. The media event refers to various events occurring while the primary reproducing apparatus is reproducing content. Examples of the media event include a Media Time Event and a Rate Change Event. The disk event refers to events occurring when the primary reproducing apparatus changes a disk. Examples of the disk event include a Disc Insert Event and a Disc Eject Event. The title event occurs due to a title change by the primary reproducing apparatus. Examples of the title event include a Title Change Event.

The user operation event occurs due to a user manipulating his or her primary reproducing apparatus or secondary reproducing apparatus. The secondary reproducing apparatus may be controlled using the user operation event that is generated by the user via a remote controller or an input device of the primary reproducing apparatus. In addition, the secondary reproducing apparatus may send a user operation event to control the primary reproducing apparatus.

When request sending or event information sending between the secondary reproducing apparatus and the primary reproducing apparatus fails, the primary reproducing apparatus and the secondary reproducing apparatus may inform the opposite party that the request or the event information has failed to be send, by transmitting a predefined error value. An event occurred here is an error event. The error value may be expressed as a combination of numbers and/or characters. Event information may include an actual data value 1820 according to the event type, and the error value may be described as the actual data value 1820 included in the event information. A non-predefined event may be sent. In this case, a description about the event may be used for the actual data value 1820. The description may be in any form, such as an HTML or a text. When event information for an error event or a non-predefined event is received, a receiving apparatus may display the event information such as a data value, on a screen thereof to inform a user that the error event or non-predefined event has been received. The event information may further include other necessary information, for example, an event name 1814.

Reproduction description information included in screen composition information may be activated at a specific time and by a specific manipulation. The reproduction description information may be activated by an event that a predetermined time point has been reached, an event that an application of a disk of the primary reproducing apparatus is executed, or an event that occurs due to a user's manipulation.

An event may occur in response to a specific operation of an application of the disk of the primary reproducing apparatus. As for Blu-ray disks, an event may occur at an arbitrary time via an HDMV IG/BDJava Application. A user may generate an event via a GUI of a reproducing apparatus. Generated events may be predefined in related standards. The primary reproducing apparatus and the secondary reproducing apparatus may respectively include separate managers to process an event. According to an exemplary embodiment, a screen composition manager processes an event.

FIG. 19 is a block diagram for explaining a Blue-ray Disk-ROM (BD-ROM) system model including a screen composition manager, according to an exemplary embodiment.

Referring to FIG. 19, the BD-ROM system model includes BD-ROM resident system software 1910, a BD-ROM application environment 1920, a BD-ROM player model 1930, decoders 1940, planes 1950, a BD-ROM disk 1960, a local storage 1970, and a network 1980. The BD-ROM resident system software 1910 includes a screen composition manager 1990 according to an exemplary embodiment. The screen composition manager 1990 is a module that performs all processes necessary to provide additional content to a secondary reproducing apparatus. The screen composition manager 1990 may be implemented to exist over an existing HDMV module and a BD-J module included in the BD-ROM application environment 1920. The secondary reproducing apparatus may also include a processing module that performs a role corresponding to the role of the screen composition manager 1990 of the primary reproducing apparatus.

The screen composition manager 1990 performs at least one of the following operations.

(1) Maintaining and sending information about the primary reproducing apparatus

(2) Processing a screen composition information file

(3) Communication with a secondary reproducing apparatus

(4) Managing a network server for communication with the secondary reproducing apparatus

(5) Provision of appropriate screen composition in response to a request from the secondary reproducing apparatus

(6) Managing/processing an event and a command delivered between the primary reproducing apparatus and the secondary reproducing apparatus

(7) Determining whether the request from the secondary reproducing apparatus is appropriate

(8) Copying or sequentially transmitting additional content stored in the primary reproducing apparatus to the secondary reproducing apparatus

(9) Processing and management of resources that are provided by the primary reproducing apparatus via the screen composition information

When the primary reproducing apparatus transmits the additional content to the secondary reproducing apparatus, the screen composition manager 1990 manages a state of resource usage of the primary reproducing apparatus. When resources are deficient or it is impossible to provide services to the secondary reproducing apparatus using current resources, such as disk extraction, the screen composition manager 1990 informs the secondary reproducing apparatus of a state change representing that services may not be provided to the secondary reproducing apparatus.

(10) Sending an event associated with the secondary reproducing apparatus

(11) Downloading an item that is to be downloaded onto the screen composition information via a network, before a user uses the item

According to the state of the network, the size of additional content specified on the screen composition information, or the setting of the screen composition information, the additional content may need to be downloaded in advance into the primary reproducing apparatus before being used by a user. The user may select screen composition information of interest, reproduction description information of interest, or reproduction media of interest corresponding to additional content and may request the screen composition manager 1990 to download data into a reproducing apparatus in advance at a time point desired by the user. In response to a request to acquire data existing on a network from the user, the screen composition manager 1990 checks whether the data has already been downloaded into the reproducing apparatus. If the data has already been downloaded into the reproducing apparatus, the screen composition manager 1990 provides the data existing in the reproducing apparatus to the user. To this end, the screen composition manager 1990 may need to record and maintain location and access information of the data previously downloaded into the reproducing apparatus and stored therein, corresponding to files and data existing on the network.

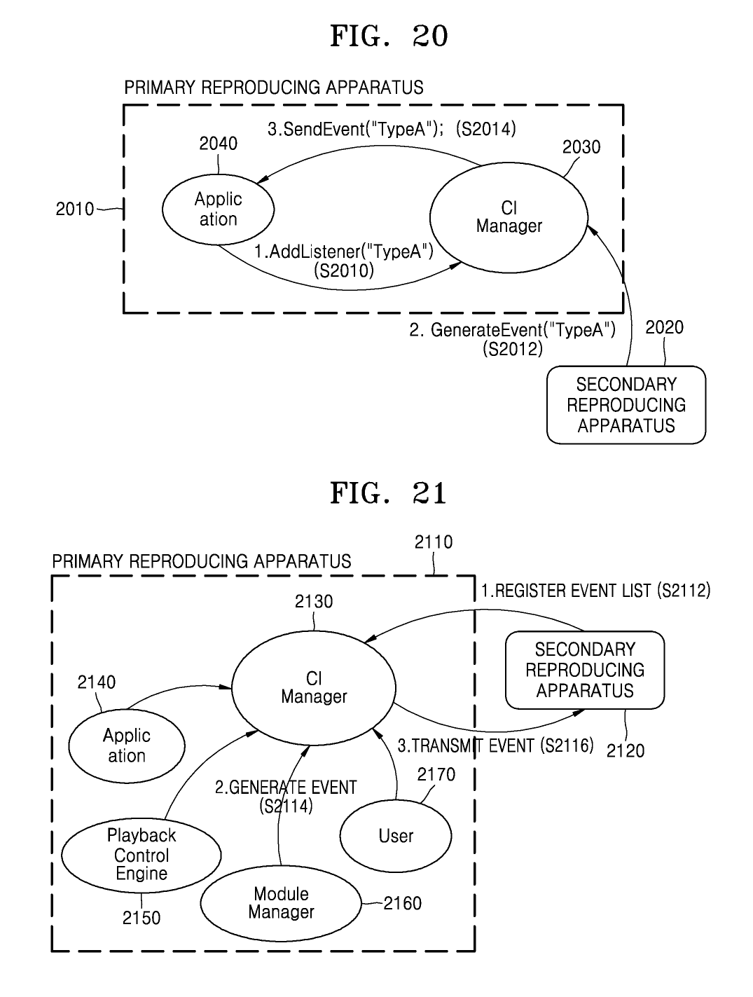

FIG. 20 is a block diagram for explaining processing of a generated event in a secondary reproducing apparatus, according to an exemplary embodiment.

Referring to FIG. 20, an application 2040 of a disk, such as a java application, may acquire an event that occurs in a secondary reproducing apparatus 2020, in order to interoperate with the secondary reproducing apparatus 2020 that the application 2040 is interested in. The application 2040 requests a screen composition manager 2030 to register an event therein or remove a registered event therefrom, in order to manage a list of events that the application 2040 desires to receive.

In operation S2010, the application 2040, which is driven in a primary reproducing apparatus 2010, registers an event that the application 2040 desires to receive, in the screen composition manager 2030. The event registration may be performed using an Application Programming Interface (API) of a predefined screen composition manager. For example, an event called TypeA is registered using an API AddListener (“TypeA”). The secondary reproducing apparatus 2020 sends a generated event to a network server of the primary reproducing apparatus 2010 connected via a network. The screen composition manager 2030 receives the generated event via the network server and processes the same. When the event TypeA is generated in the secondary reproducing apparatus 2020 and sent to the screen composition manager 2030 via the network server in operation S2012, the screen composition manager 2030 processes the event received via the network server. The screen composition manager 2030 determines whether the event received from the secondary reproducing apparatus 2020 is an event that the application 2040 has registered using the AddListener( ) API. When the event received from the secondary reproducing apparatus 2020 is an event that the application 2040 has registered, the screen composition manager 2030 transmits the received event to the application 2040, in operation S2014. Here, the screen composition manager 2030 may change the format of the received event to a format interpretable by the application 2040 and transmit the event having the interpretable format to the application 2040.

FIG. 21 is a block diagram for explaining processing of a generated event in a primary reproducing apparatus, according to an exemplary embodiment.

When a screen composition manager 2130 of a primary reproducing apparatus 2110 sends screen composition information or reproduction description information to a secondary reproducing apparatus 2120, the secondary reproducing apparatus 2120 may obtain a list of necessary events from the screen composition information file. Further, the secondary reproducing apparatus 2120 may send a list of events of interest to the primary reproducing apparatus 2110 and register the list of events of interest in the screen composition manager 2130 of the primary reproducing apparatus 2110, in operation S2112. In operation S2114, the screen composition manager 2130 receives event information about a event occurred by an application 2140, a playback control engine 2150, a module manager 2160, or manipulation of a user 2170 of the primary reproducing apparatus 2110. The screen composition manager 2130 checks whether there exists a secondary reproducing apparatus interested in the received event information. In other words, it is checked whether there exist the secondary reproducing apparatus 2120 that has registered the received event. In operation S2116, the screen composition manager 2130 sends the received event to the secondary reproducing apparatus 2120 interested in the received event. Here, the screen composition manager 2130 may change the format of event information to a format interpretable by the secondary reproducing apparatus 2120 and transmit the event information having the interpretable format to the secondary reproducing apparatus 2120.

According to another embodiment of the exemplary embodiments, the screen composition manager 2130 of the primary reproducing apparatus 2110 sends an event to all secondary reproducing apparatuses on a network, regardless of an event list registered by the secondary reproducing apparatuses. In this case, the secondary reproducing apparatuses may receive and process only desired events.

FIG. 22 is a schematic diagram for explaining processing of an event generated in a secondary reproducing apparatus, according to an exemplary embodiment. In FIG. 22, a process in which the secondary reproducing apparatus is used as a remote controller for controlling an operation of a primary reproducing apparatus is illustrated.

In operation S2212, a secondary reproducing apparatus 2220 generates a command and transmits the command to a screen composition manager 2230 of a primary reproducing apparatus 2210. The command transmission may be performed by an application installed in the secondary reproducing apparatus 2220 or by another processing module of the secondary reproducing apparatus 2220 that corresponds to the screen composition manager 2230. The screen composition manager 2230 determines whether the received command is transmitted by an authorized user or the secondary reproducing apparatus 2220, and, if so, transmits the received command to the playback control engine 2240 or the module manager 2250 so that playback control engine 2240 or the module manager 2250 may perform an operation corresponding to the command. The command is not processed by an application installed in the primary reproducing apparatus 2210 but is transmitted to the playback control engine 2240 or the module manager 2250, which controls media playback or change a title according to the received command.

Communication between a secondary reproducing apparatus and a primary reproducing apparatus needs to be controlled by a user. A value set according to an intention of the user needs to be used and referred to by a screen composition manager. An application of a disk may need to process an application operation, based on a current setting state and a current operation state. In order for different modules to access state information necessary for providing additional content as described above, a separate information file or a separate register containing the state information may be used.

A register of the primary reproducing apparatus may store state information indicating at least one of the following.

(1) Whether available screen composition information exists in a disk that is being currently played back

(2) The number of secondary reproducing apparatuses currently accessing the primary reproducing apparatus

(3) The maximum number of secondary reproducing apparatuses simultaneously accessing the primary reproducing apparatus

(4) Whether a network device in the primary reproducing apparatus can be used

(5) Setting information for controlling an access to the primary reproducing apparatus

An access to a primary reproducing apparatus by a secondary reproducing apparatus may be controlled via setting by a user. For example, all requests from the secondary reproducing apparatus may be processed without an authentication procedure, only requests from secondary reproducing apparatuses authorized via authentication procedure may be processed, or no requests from the secondary reproducing apparatus may be processed, based on the user's setting. The setting information may be stored in a register of the primary reproducing apparatus. When an authentication procedure is necessary, authentication may be performed using a PIN preset in the register.

The user may limit services that are provided to the secondary reproducing apparatus. For example, the user may determine whether to allow copying of media corresponding to additional content, a screen composition information index file, or a screen composition information file into the secondary reproducing apparatus, whether to allow broadcasting of content reproduced by the primary reproducing apparatus to the secondary reproducing apparatus, and whether to require authentication of the secondary reproducing apparatus. The user's setting may be stored in the register.

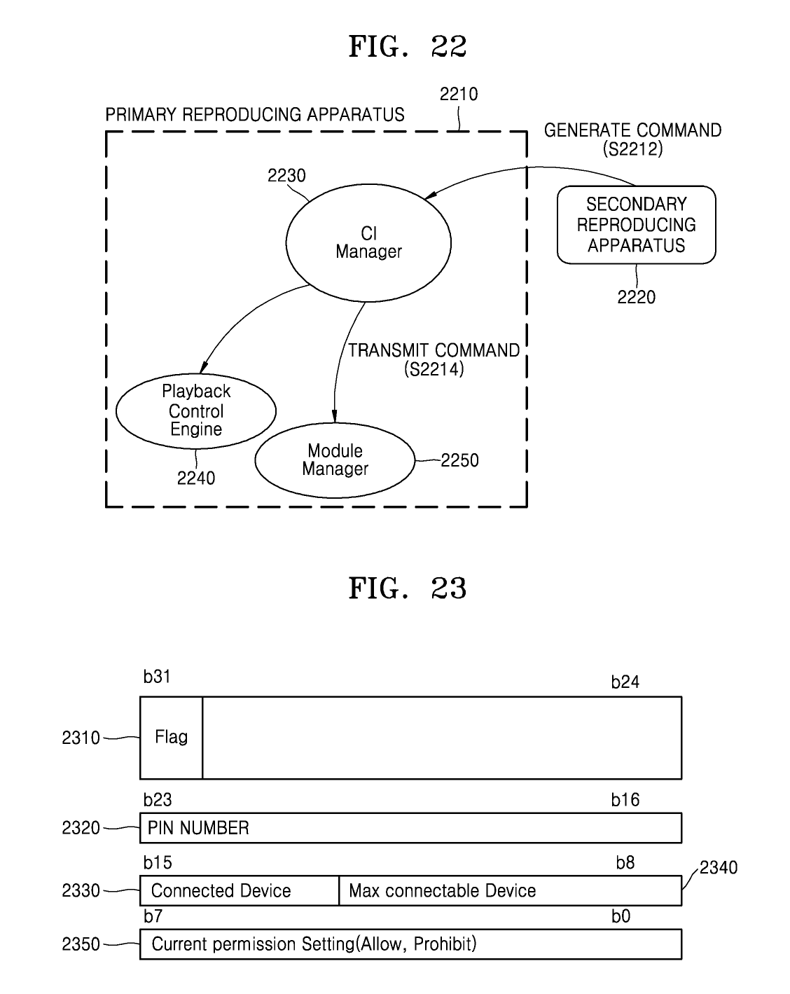

FIG. 23 illustrates a state register according to an exemplary embodiment. Referring to FIG. 23, a flag 2310 representing various types of information set by a user or a screen composition manager, a PIN 2320 used in an authentication procedure, a number 2330 of secondary reproducing apparatuses connected to a primary reproducing apparatus, a maximum number 2340 of secondary reproducing apparatuses allowed to simultaneously access the primary reproducing apparatus, and information 2350 representing whether an access to the primary reproducing apparatus is possible, may be stored in the register.

According to an exemplary embodiment, media associated with a disk may be enjoyed via not only a screen output apparatus connected to a reproducing apparatus, but also a terminal such as a mobile phone that is connected to the reproducing apparatus via a network and has an output screen.

According to a exemplary embodiment, while the reproducing apparatus is reproducing the media from the disk, another apparatus may use an interactive function associated with the media.

According to a exemplary embodiment, the primary reproducing apparatus and the secondary reproducing apparatus may perform a mutual interactive operation.

According to a exemplary embodiment, content stored in a storage medium such as, an optical disk, a hard disk, or a flash memory, and additional content that a content manufacturer desires to provide in connection with the content may be reproduced by the primary reproducing apparatus and the secondary reproducing apparatus according to various scenarios.

Methods according to the exemplary embodiments may be implemented as program commands executable by various computers and may be recorded on a computer-readable recording medium. The computer-readable recording medium may include program commands, data files, data structures, and the like separately or in combinations. The program commands to be recorded on the computer-readable recording medium may be specially designed and configured for embodiments of the exemplary embodiments or may be well-known to and be usable by one of ordinary skill in the art of computer software. Examples of the computer-readable recording medium include a magnetic medium such as a hard disk, a floppy disk, or a magnetic tape, an optical medium such as a compact disk-read-only memory (CD-ROM) or a digital versatile disk (DVD), a magneto-optical medium such as a floptical disk, and a hardware device specially configured to store and execute program commands such as a ROM, a random-access memory (RAM), or a flash memory. Examples of the program commands are advanced language codes that can be executed by a computer using an interpreter or the like as well as machine language codes made by a compiler.

The exemplary embodiments should be considered in descriptive sense only and not for purposes of limitation. Descriptions of features or aspects within one exemplary embodiment should typically be considered as available for other similar features or aspects in other exemplary embodiments.

While the disclosure has been particularly shown and described with reference to exemplary embodiments, it will be understood by those of ordinary skill in the art that various changes in form and details may be made therein without departing from the spirit and scope of the disclosure as defined by the following claims.

1. A non-transitory information storage medium having data recorded thereon, the data comprising:
content which is reproducible by a primary reproducing apparatus; and
screen composition information comprising information for providing additional content associated with the content to a secondary reproducing apparatus.

2. The non-transitory information storage medium of claim 1, wherein the screen composition information further comprises information for reproducing the additional content by the secondary reproducing apparatus while the content is being reproduced by the primary reproducing apparatus.

3. The non-transitory information storage medium of claim 1, wherein the screen composition information further comprises information about a plurality of scenarios for providing additional contents to a plurality of secondary reproducing apparatuses.

4. The non-transitory information storage medium of claim 1, wherein the screen composition information further comprises reproduction description information comprising information indicating a location of the additional content.

5. The non-transitory information storage medium of claim 1, data further comprising,
the additional content comprising at least one from among additional information which is reproducible in association with the content which is reproduced by the primary reproducing apparatus, subtitle information of the content, secondary video information of the content, secondary audio information of the content, and information about an application associated with the content.

6. The non-transitory information storage medium of claim 1, the data further comprising index information about the screen composition information.

7. A reproducing apparatus comprising:
a reader configured to read content and screen composition information from an information storage medium, the screen composition information comprising information for providing additional content associated with the content to the secondary reproducing apparatus;
a communicator configured to communicate with the secondary reproducing apparatus;
a reproducer configured to reproduce the content; and
a controller configured to transmit the screen composition information to the secondary reproducing apparatus.

8. A method of reproducing content in a reproducing apparatus, the method comprising:
reading content and screen composition information from an information storage medium, the screen composition information comprising information for providing additional content associated with the content to a secondary reproducing apparatus;
reproducing the content; and
transmitting the screen composition information to the secondary reproducing apparatus.

9. A computer-readable recording medium having recorded thereon a program for executing a method of reproducing content in a reproducing apparatus, the method comprising:
reading main content and screen composition information from an information storage medium, the screen composition information comprising information for providing additional content associated with the content to a secondary reproducing apparatus;
reproducing the content; and
transmitting the screen composition information to the secondary reproducing apparatus.

10. A reproducing apparatus comprising:
a communicator configured to communicate with a primary reproducing apparatus which reproduces content;
a controller configured to receive screen composition information from the primary reproducing apparatus, the screen composition information comprising information for providing additional content associated with the content that is reproduced by the primary reproducing apparatus, and to obtain additional content associated with the content using the screen composition information; and
a reproducer configured to reproduce the obtained additional content.

11. A method of reproducing additional content in a reproducing apparatus, the method comprising:
receiving screen composition information from a primary reproducing apparatus which reproduces content, the screen composition information comprising information for providing additional content associated with content that is reproduced by a primary reproducing apparatus;
obtaining the additional content associated with the content by using the screen composition information; and
reproducing the additional content.

12. A computer-readable recording medium having recorded thereon a program for executing a method of reproducing additional content in a reproducing apparatus, the method comprising:
receiving screen composition information from a primary reproducing apparatus which reproduces content;
obtaining the additional content associated with the content using the screen composition information; and
reproducing the additional content.

13. A recording apparatus comprising:
a writer configured to write data to an information storage medium; and
a controller configured to control the writer to write, to the information storage medium, content that is reproducible by a primary reproducing apparatus and screen composition information comprising information for providing additional content associated with the content to a secondary reproducing apparatus.

14. A recording method comprising:
writing content which is reproducible by a primary reproducing apparatus, to an information storage medium; and
writing, to the information storage medium, screen composition information comprising information for providing additional content associated with the content to a secondary reproducing apparatus.

15. A computer-readable recording medium having recorded thereon a program for executing a recording method comprising:
writing content which is reproducible by a primary reproducing apparatus, to an information storage medium; and
writing, to the information storage medium, screen composition information comprising information for providing additional content associated with the content to a secondary reproducing apparatus.
